(19) United States
(12) Patent Application Publication
(10) Pub. No.: US 2021/0365431 A1
(43) Pub. Date: Nov. 25, 2021

(54) FALSE SUBMISSION FILTER DEVICE, FALSE SUBMISSION FILTER SYSTEM, FALSE SUBMISSION FILTER METHOD, AND COMPUTER READABLE MEDIUM

(71) Applicant: MITSUBISHI ELECTRIC CORPORATION, Tokyo (JP)

(72) Inventors: Tomonori NEGI, Tokyo (JP); Kiyoto KAWAUCHI, Tokyo (JP); Yukio IZUMI, Tokyo (JP); Takeshi ASAI, Tokyo (JP); Takumi YAMAMOTO, Tokyo (JP); Hiroki NISHIKAWA, Tokyo (JP); Keisuke KITO, Tokyo (JP); Kohei TAMMACHI, Tokyo (JP)

(73) Assignee: MITSUBISHI ELECTRIC CORPORATION, Tokyo (JP)

(21) Appl. No.: 16/603,138

(22) PCT Filed: May 25, 2017
(86) PCT No.: PCT/JP2017/019586

§ 371 Date: Oct. 4, 2019

(51) Int. Cl. G06F 16/23; G06F 16/9537

(52) U.S. Cl. CPC G06F 16/2365; G06F 16/9537

(57) ABSTRACT

In an SNS server (103) corresponding to a false submission filter device, an event specifying unit (604) analyzes contents of a submission informing of an occurrence of an event and specifies a location (721) of occurrence of the event. A query destination specifying unit (605) searches a query destination database (613) and specifies a query destination corresponding to the location (721) specified by the event specifying unit (604). A query unit (606) transmits a request for checking the presence or absence of occurrence of the event from the observation result of one or more machines to the query destination specified by the query destination specifying unit (605). The query unit (606) receives a response to the request. A result reflecting unit (607) determines whether the contents of the submission are true or false from a check result indicated by the response received by the query unit (606). The result reflecting unit (607) performs a process in accordance with a determination result on the submission.

### TECHNICAL FIELD

The present invention relates to a false submission filter device, false submission filter system, false submission filter method, and false submission filter program.

### BACKGROUND ART

Social media typified by SNS such as Twitter (registered trademark), Facebook (registered trademark), and GREE (registered trademark) have become widespread. “SNS” is an abbreviation for Social Networking Service. On the social media, users individually send information freely, and can perform bidirectional communications.

However, since users individually send information freely, the social media is flooded with contents for maliciously slandering others, entrapping others into anxiety by stirring up fears, and including text or images against public order and morals. This causes social commotions such as flaming on the social media, civil accusations, criminal accusations, and so forth.

In recent years, legislation for assigning a criminal penalty such as a fine to a company not deleting malicious contents or user account within a certain period has been studied and under way. If not deleting malicious contents or user account within a certain period, a service provider is assigned a legal punishment. Therefore, with manual monitoring of submitted contents, notifications by users, and so forth, service providers such as SNS delete malicious contents and user account.

Patent Literature 1 discloses a scheme of analyzing information reliability by repeatedly getting information from different information sources until acquiring certain reliability on the precondition that the whole big data can be freely acquired from sensor networks, SNS, and so forth.

Patent Literature 2 discloses a scheme of measuring, by near-field wireless communication, the number of terminal devices such as smartphones and portable telephones that are present around a submitter, handling the number of terminals as curious onlookers, and evaluating credibility of a submitted article based on the number of curious onlookers and history of deployment of emergency vehicles.

Patent Literature 3 discloses a scheme of determining false information based on the number of submissions of articles against a submitted article.

### CITATION LIST

### Patent Literature

Patent Literature 1: JP 2016-224710

Patent Literature 2: JP 2016-15008

Patent Literature 3: JP 2015-5057

### SUMMARY OF INVENTION

### Technical Problem

Conventionally, with manual monitoring of submitted contents, notifications by users, and so forth, service providers such as SNS delete malicious contents and user account. Therefore, deletion of submitted contents and so forth is delayed, and malicious contents are spread. Thus, social commotions cannot be prevented.

In the technique described in Patent Literature 1, it is impossible to check whether an article submitted to SNS is true or false. Moreover, information about the sensor network is secret information for individuals and organizations such as companies. Therefore, it is difficult to assume that service providers such as SNS can freely acquire all information such as the information about the sensor network. That is, the technique described in Patent Literature 1 is unrealistic.

In the techniques described in Patent Literature 2 and Patent Literature 3, true/false evaluation based on surveillance information from machines such as a sensor and surveillance camera is not performed.

An object of the present invention is to perform both of quickly taking measures against false submission by determining whether the contents of the submission are true or false from the observation result of the machine and handling the observation result of the machine as secret information.

### Solution to Problem

A false submission filter device according to an aspect of the present invention may include:

an event specifying unit to analyze contents of a submission informing of an occurrence of an event and to specify a location of occurrence of the event;

a query destination specifying unit to search a query destination database which stores data associating locations observed by one or more machines and query destinations of a management subject which manages the one or more machines and to specify a query destination corresponding to the location specified by the event specifying unit;

a query unit to transmit a request for checking presence or absence of occurrence of the event from the observation result of the one or more machines to the query destination specified by the query destination specifying unit and to receive a response to the request; and

a result reflecting unit to determine whether the contents of the submission are true or false from a check result indicated by the response received by the query unit and to perform a process in accordance with a determination result on the submission.

### Advantageous Effects of Invention

According to the present invention, since a work of checking whether the contents of the submission are correct or not from the observation result of the machine is performed by the management subject managing the machine, the observation result of the machine can be handled as secret information. Since the query destination of the management subject is selected based on the result of analyzing the contents of the submission, a query can be quickly made. Therefore, it is possible to perform both of quickly taking measures against false submission by determining whether the contents of the submission are true or false from the observation result of the machine and handling the observation result of the machine as secret information.

### BRIEF DESCRIPTION OF DRAWINGS

FIG. 1 illustrates the configuration of a false submission filter system according to Embodiment 1.

FIG. 2 is a block diagram illustrating the configuration of a terminal according to Embodiment 1.

FIG. 3 is a block diagram illustrating the configuration of an SNS server according to Embodiment 1.

FIG. 4 is a block diagram illustrating the configuration of a submission determination unit according to Embodiment 1.

FIG. 5 is a block diagram illustrating the configuration of an event specifying unit according to Embodiment 1.

FIG. 6 is a block diagram illustrating the configuration of a location specifying unit according to Embodiment 1.

FIG. 7 is a block diagram illustrating the configuration of a DS server according to Embodiment 1.

FIG. 8 is a block diagram illustrating the configuration of a machine management device according to Embodiment 1.

FIG. 9 illustrates a correspondence table registered in a machine database according to Embodiment 1.

FIG. 10 illustrates a correspondence table registered in a query destination database according to Embodiment 1.

FIG. 11 illustrates a correspondence table registered in a state change database according to Embodiment 1.

FIG. 12 illustrates a correspondence table registered in an installation location database according to Embodiment 1.

FIG. 13 is a sequence diagram illustrating a communication flow of the false submission filter system according to Embodiment 1.

FIG. 14 is a flowchart illustrating a process flow of the SNS server according to Embodiment 1.

FIG. 15 is a flowchart illustrating a process flow of the SNS server according to Embodiment 1.

FIG. 16 is a flowchart illustrating a process flow of the DS server according to Embodiment 1.

FIG. 17 is a flowchart illustrating a process flow of the machine management device according to Embodiment 1.

FIG. 18 is a flowchart illustrating a process flow of the machine management device according to Embodiment 1.

FIG. 19 is a flowchart illustrating a process flow of the submission determination unit according to Embodiment 1.

FIG. 20 is a flowchart illustrating a process flow of the event specifying unit according to Embodiment 1.

FIG. 21 is a flowchart illustrating a process flow of the location specifying unit according to Embodiment 1.

FIG. 22 is a flowchart illustrating a process flow of the location specifying unit according to Embodiment 1.

FIG. 23 is a flowchart illustrating a process flow of the location specifying unit according to Embodiment 1.

FIG. 24 is a block diagram illustrating the configuration of a terminal according to Embodiment 2.

FIG. 25 is a block diagram illustrating the configuration of an SNS server according to Embodiment 2.

FIG. 26 is a block diagram illustrating the configuration of a machine management device according to Embodiment 2.

FIG. 27 illustrates a correspondence table registered in a machine database according to Embodiment 2.

FIG. 28 illustrates a correspondence table registered in an installation location database according to Embodiment 2.

FIG. 29 is a sequence diagram illustrating a communication flow of a false submission filter system according to Embodiment 2.

FIG. 30 is a flowchart illustrating a process flow of the terminal according to Embodiment 2.

FIG. 31 is a flowchart illustrating a process flow of the terminal according to Embodiment 2.

FIG. 32 is a flowchart illustrating a process flow of the machine management device according to Embodiment 2.

FIG. 33 illustrates the configuration of a false submission filter system according to Embodiment 3.

FIG. 34 is a block diagram illustrating the configuration of a network device according to Embodiment 3.

FIG. 35 illustrates a correspondence table registered in a machine database according to Embodiment 3.

FIG. 36 illustrates a correspondence table registered in a query destination database according to Embodiment 3.

FIG. 37 is a sequence diagram illustrating a communication flow of the false submission filter system according to Embodiment 3.

FIG. 38 is a flowchart illustrating a process flow of the network device according to Embodiment 3.

FIG. 39 is a flowchart illustrating a process flow of the network device according to Embodiment 3.

FIG. 40 is a flowchart illustrating a process flow of a machine management device according to Embodiment 3.

### DESCRIPTION OF EMBODIMENTS

In the following, embodiments of the present invention are described by using the drawings. In each drawing, identical or corresponding portions are provided with the same reference characters. In the description of the embodiments, description of identical or corresponding portions is omitted or simplified as appropriate. Note that the present invention is not limited to the embodiments described in the following, but can be variously modified as required. For example, of the embodiments described in the following, two or more embodiments may be combined and implemented.

Alternatively, of the embodiments described in the following, one embodiment or a combination of two or more embodiments may be partially implemented.

### Embodiment 1

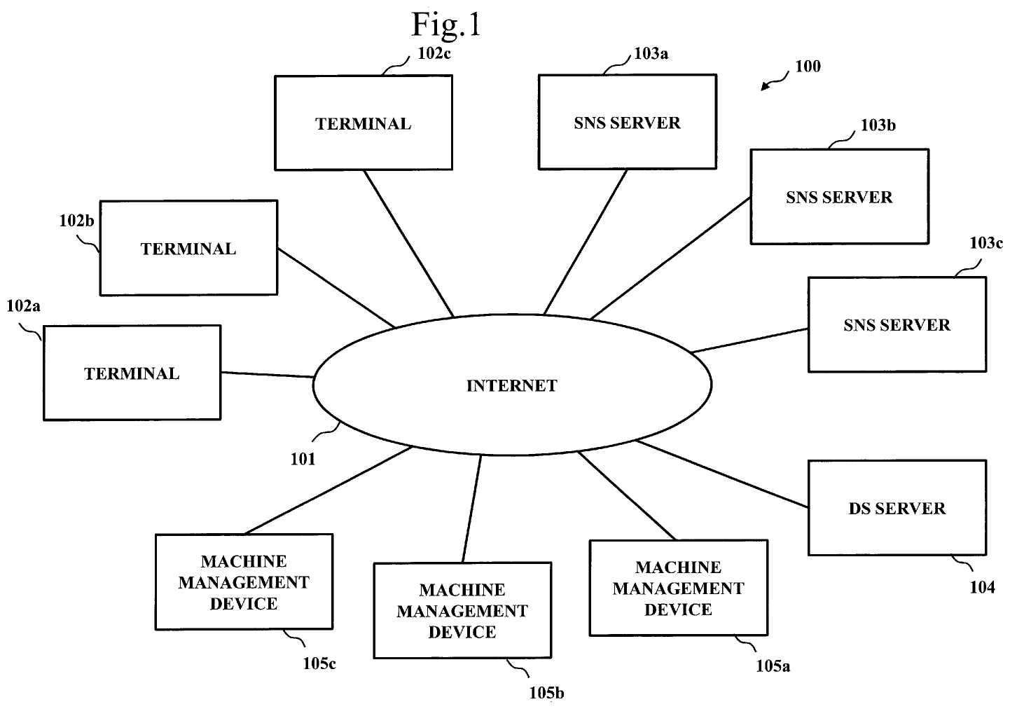

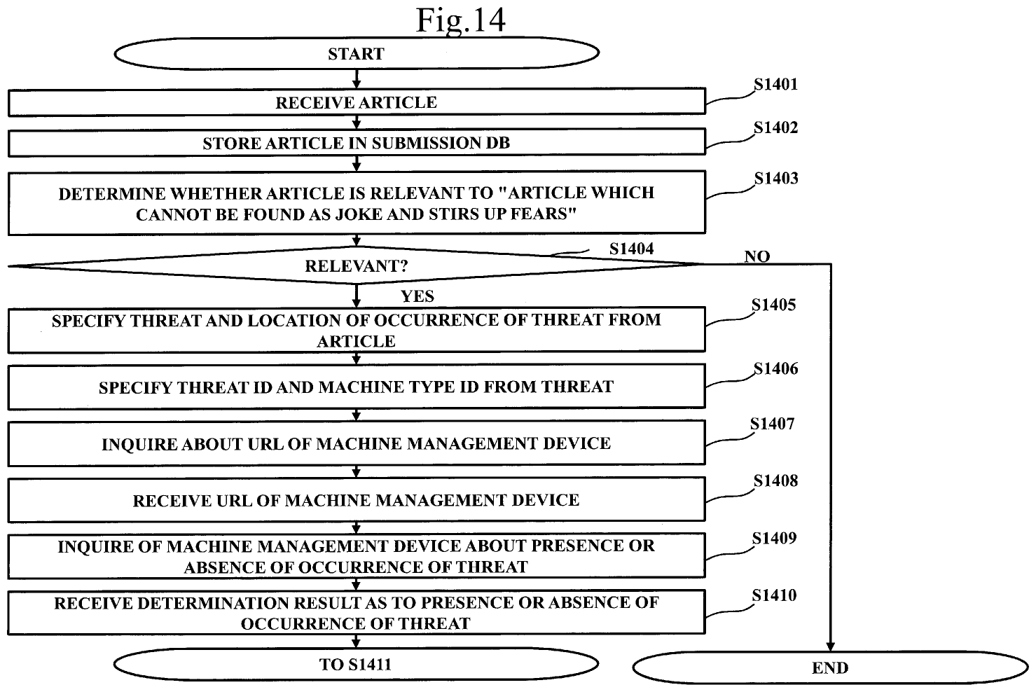

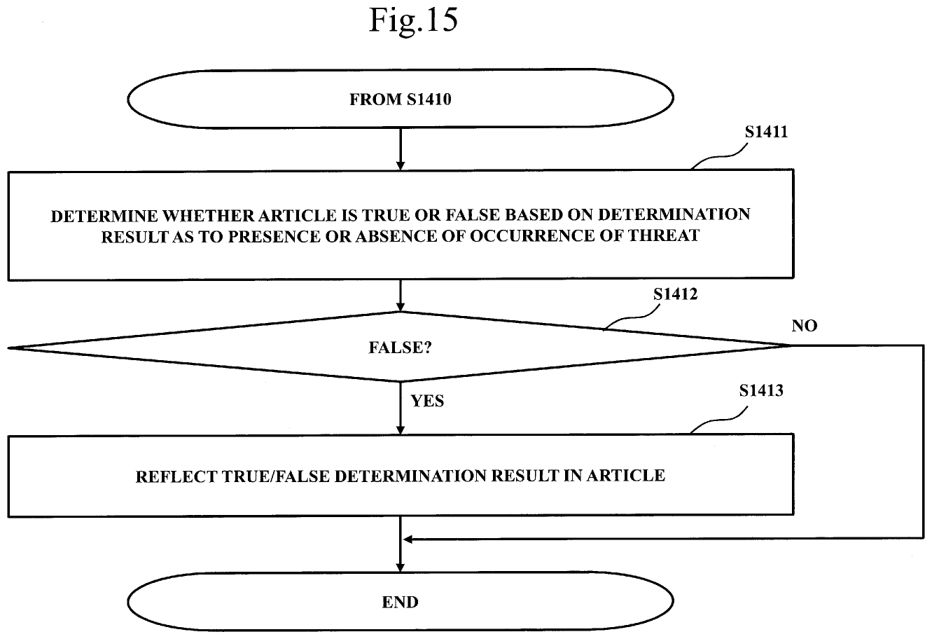

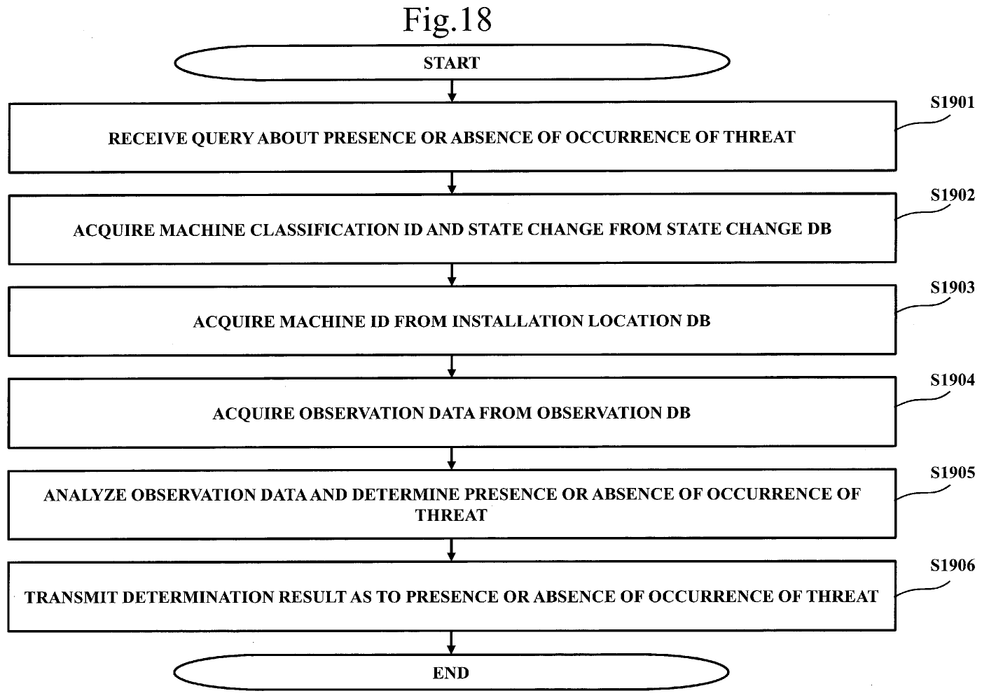

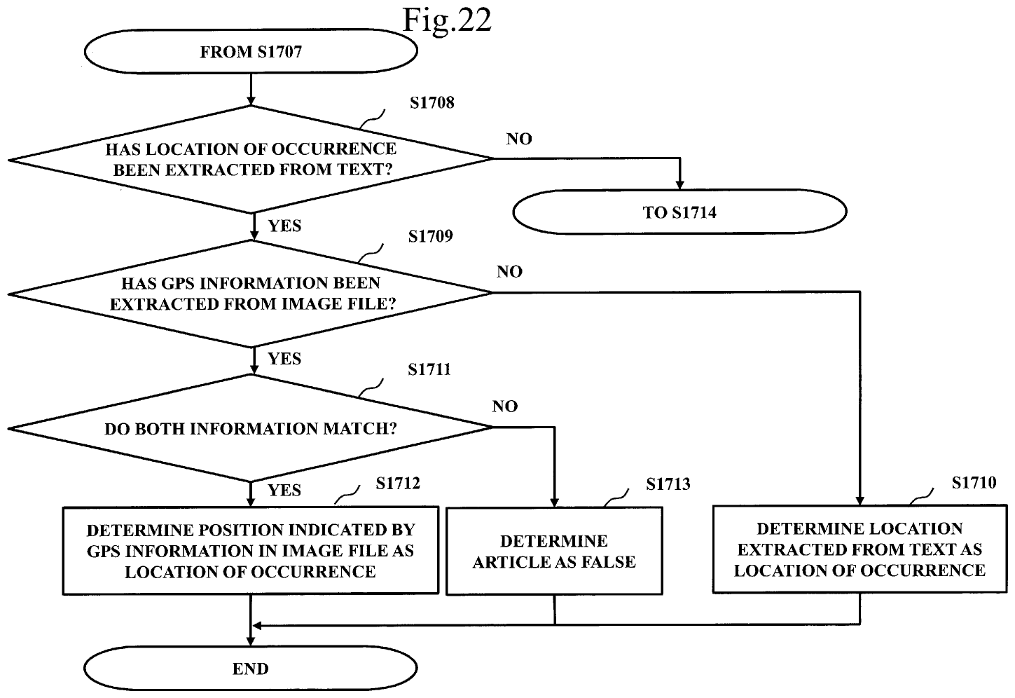

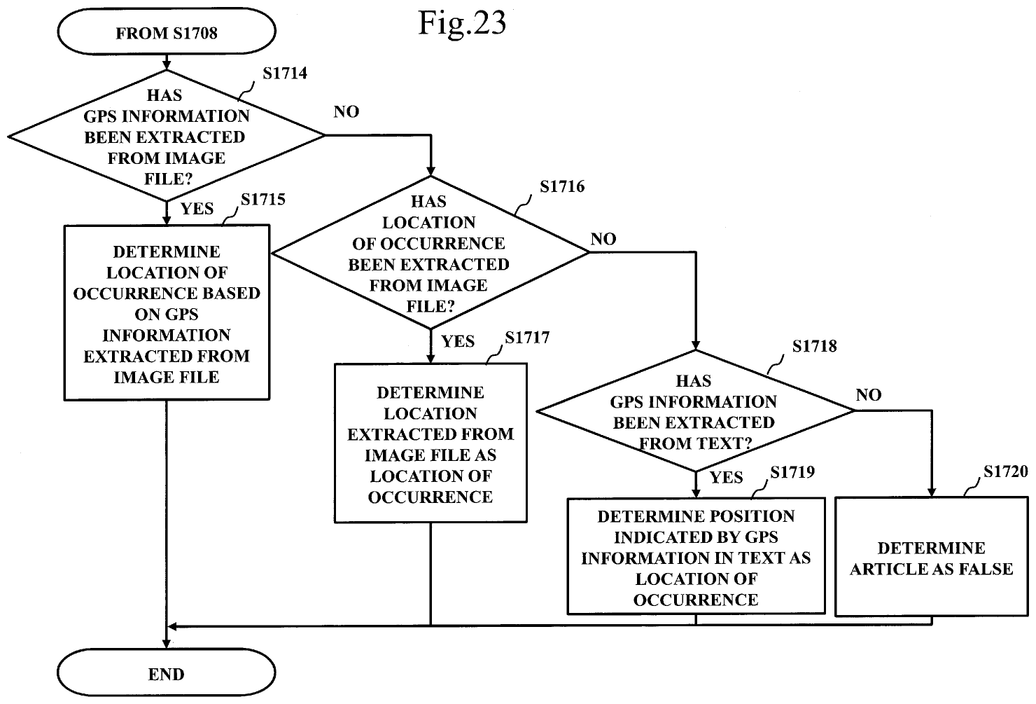

The present embodiment is described by using FIG. 1 to FIG. 23.

### Description of Configuration

With reference to FIG. 1, the configuration of a false submission filter system 100 according to the present embodiment is described.

The false submission filter system 100 includes a plurality of terminals 102a, 102b, 102c, . . . , a plurality of SNS servers 103a, 103b, 103c, . . . , a DS server 104, and a plurality of machine management devices 105a, 105b, 105c, . . . . “DS” is an abbreviation for Directory Service.

Note that in place of the plurality of terminals 102a, 102b, 102c, . . . , only one terminal 102a may be included in the false submission filter system 100. In place of plurality of SNS servers 103a, 103b, 103c, . . . , only one SNS server 103a may be included in the false submission filter system 100. A plurality of DS servers 104a, 104b, 104c, . . . may be included in the false submission filter system 100.

In the following, the plurality of terminals 102a, 102b, 102c, . . . are collectively referred to as a terminal 102. The plurality of SNS servers 103a, 103b, 103c, . . . are collectively referred to as an SNS server 103. The plurality of machine management devices 105a, 105b, 105c, . . . are collectively referred to as a machine management device 105.

The SNS server 103 is connected via the Internet 101 to the terminal 102 for use in submission and viewing by a user. The terminal 102 is, for example, a PC or smartphone. “PC” is an abbreviation for Personal Computer.

The SNS server 103 is connected via the Internet 101 to the machine management device 105 as a management subject which manages one or more machines and to the DS server 104 which manages a query destination of the management subject.

In the present embodiment, the SNS server 103 corresponds to a false submission filter device. The SNS server 103 is a server which accepts a submission from the terminal 102 of the user and publishes the submission on a network. The submission is a submission to SNS in the present embodiment, but may be a submission to a service other than SNS, or a site. The network as a publishing destination is the Internet 101 in the present embodiment, but may be a network of another type, such as an intranet of a company.

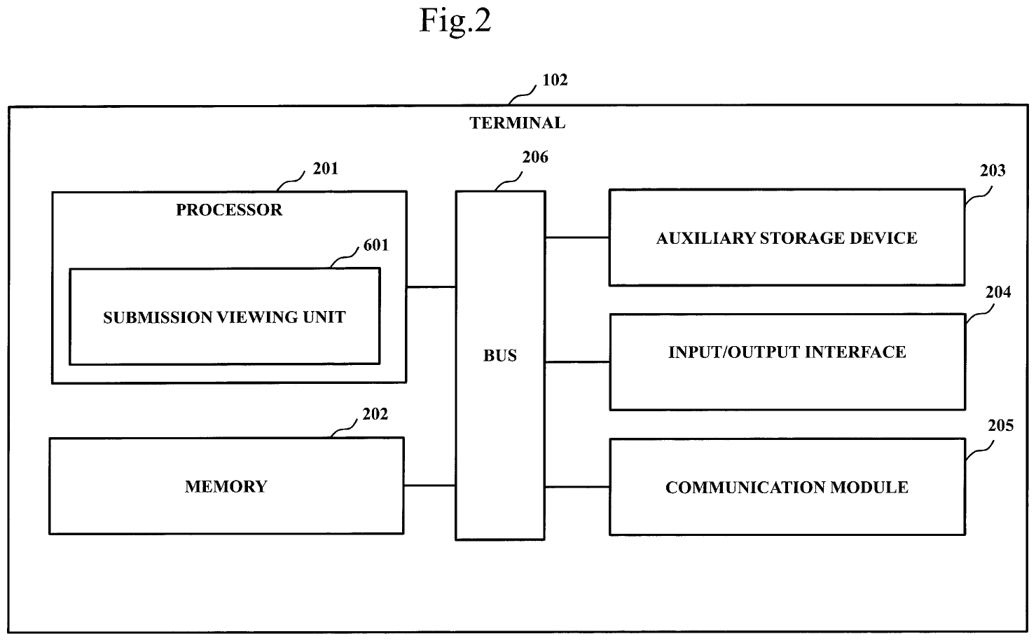

With reference to FIG. 2, the configuration of the terminal 102 according to the present embodiment is described.

The terminal 102 is a computer. The terminal 102 includes a processor 201 and other pieces of hardware such as a memory 202, an auxiliary storage device 203, an input/output interface 204, and a communication module 205. The processor 201 is connected via a bus 206 to the other pieces of hardware to control these other pieces of hardware.

The terminal 102 includes a submission viewing unit 601. The function of the submission viewing unit 601 is implemented by software.

The processor 201 is a device which executes a submission program. The submission program is a program which implements the function of the submission viewing unit 601. The submission program is, specifically, a web browser or dedicated application. The processor 201 is, for example, a CPU. “CPU” is an abbreviation for Central Processing Unit.

The memory 202 and the auxiliary storage device 203 are devices which store the submission program. The memory 202 is, for example, a flash memory or RAM. “RAM” is an abbreviation for Random Access Memory. The auxiliary storage device 203 is, for example, a flash memory or HDD. “HDD” is an abbreviation for Hard Disk Drive.

The submission program is stored in advance in the auxiliary storage device 203. The submission program is loaded onto the memory 202, read to the processor 201, and executed by the processor 201. In the auxiliary storage device 203, not only the submission program but also an OS is stored. “OS” is an abbreviation for Operating System. The processor 201 executes the submission program while executing the OS.

Note that a part or entire of the submission program may be incorporated in the OS.

The input/output interface 204 includes an input interface to which an input device not illustrated is connected and an output interface to which a display not illustrated is connected. The input device is a device to be operated by the user to input data to the submission program. The input device is, for example, a mouse, keyboard, or touch panel. The display is a device which displays data outputted from the submission program on a screen. The display is, for example, an LCD. “LCD” is an abbreviation for Liquid Crystal Display.

The communication module 205 includes a receiver which receives data inputted to the submission program and a transmitter which transmits data outputted from the submission program. The communication module 205 is, for example, a communication chip or NIC. “NIC” is an abbreviation for Network Interface Card. The communication module 205 is connected directly or via LAN to the Internet 101. “LAN” is an abbreviation for Local Area Network.

The terminal 102 may include a plurality of processors which replace the processor 201. The plurality of these processors share execution of the submission program. Each processor is, for example, a CPU.

Data, information, signal values, and variable values to be used, processed, or outputted by the submission program are stored in the memory 202, the auxiliary storage device 203, or a register or cache memory in the processor 201.

The submission program is a program which causes the computer to execute a “process” wherein the “unit” of the submission viewing unit 601 is read as “process”. Alternatively, the submission program is a program which causes the computer to execute a “procedure” wherein the “unit” of the submission viewing unit 601 is read as “procedure”. The submission program may be provided as being recorded on a computer-readable medium or provided as a program product.

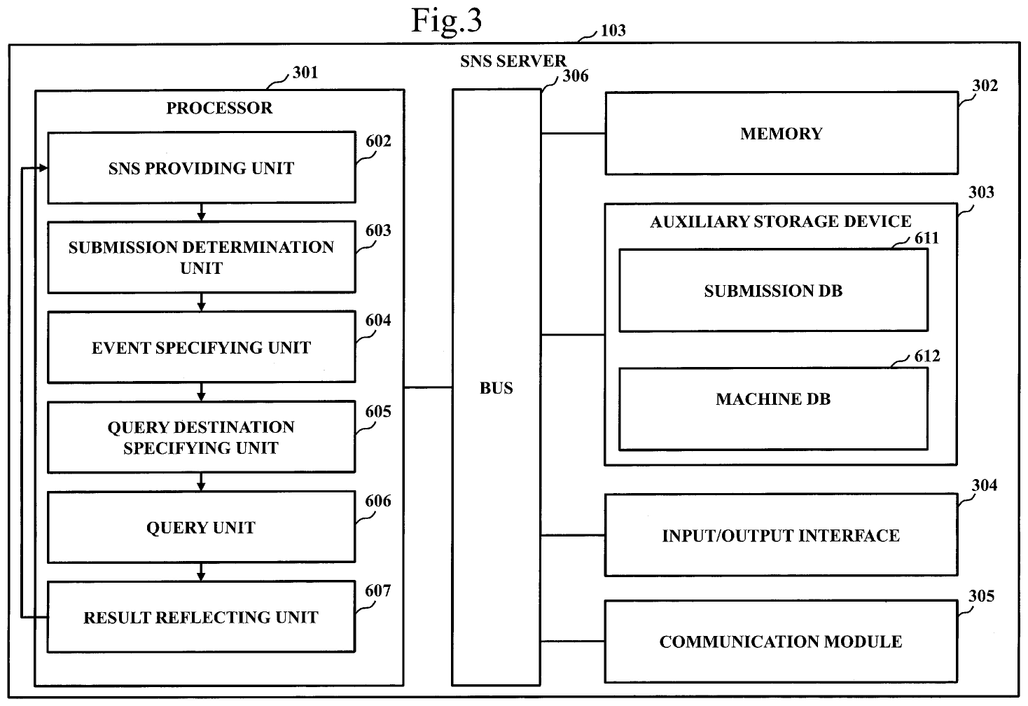

With reference to FIG. 3, the configuration of the SNS server 103 according to the present embodiment is described.

The SNS server 103 is a computer. The SNS server 103 includes a processor 301 and other pieces of hardware such as a memory 302, an auxiliary storage device 303, an input/output interface 304, and a communication module 305. The processor 301 is connected via a bus 306 to the other pieces of hardware to control these other pieces of hardware.

The SNS server 103 includes an SNS providing unit 602, a submission determination unit 603, an event specifying unit 604, a query destination specifying unit 605, a query unit 606, a result reflecting unit 607, a submission database 611, and a machine database 612. The functions of the SNS providing unit 602, the submission determination unit 603, the event specifying unit 604, the query destination specifying unit 605, the query unit 606, and the result reflecting unit 607 are implemented by software. The submission database 611 and the machine database 612 may be constructed on the memory 302, but is constructed in the auxiliary storage device 303 in the present embodiment. The submission database 611 is a database which stores and manages submitted articles from the terminal 102. The machine database 612 will be described further below.

The processor 301 is a device which executes an SNS program and a false submission filter program. The SNS program is a program which implements the function of the SNS providing unit 602. The false submission filter program is a program which implements the functions of the submission determination unit 603, the event specifying unit 604, the query destination specifying unit 605, the query unit 606, and the result reflecting unit 607. The processor 301 is, for example, a CPU.

The memory 302 and the auxiliary storage device 303 are devices which store the SNS program and the false submission filter program. The memory 302 is, for example, a flash memory or RAM. The auxiliary storage device 303 is, for example, a flash memory or HDD.

The SNS program and the false submission filter program are stored in advance in the auxiliary storage device 303. The SNS program and the false submission filter program are loaded onto the memory 302, read to the processor 301, and executed by the processor 301. In the auxiliary storage device 303, not only the SNS program and the false submission filter program but also an OS is stored. The processor 301 executes the SNS program and the false submission filter program while executing the OS.

Note that a part or entire of the SNS program and the false submission filter program may be incorporated in the OS.

The input/output interface 304 includes an input interface to which an input device not illustrated is connected and an output interface to which a display not illustrated is connected. The input device is a device to be operated by the user to input data to the SNS program and the false submission filter program. The input device is, for example, a mouse, keyboard, or touch panel. The display is a device which displays data outputted from the SNS program and the false submission filter program on a screen. The display is, for example, an LCD.

The communication module 305 includes a receiver which receives data inputted to the SNS program and the false submission filter program and a transmitter which transmits data outputted from the SNS program and the false submission filter program. The communication module 305 is, for example, a communication chip or NIC. The communication module 305 is connected directly or via LAN to the Internet 101.

The SNS server 103 may include a plurality of processors which replace the processor 301. The plurality of these processors share execution of the SNS program and the false submission filter program. Each processor is, for example, a CPU.

Data, information, signal values, and variable values to be used, processed, or outputted by the SNS program and the false submission filter program are stored in the memory 302, the auxiliary storage device 303, or a register or cache memory in the processor 301.

The SNS program is a program which causes the computer to execute a “process” wherein the “unit” of the SNS providing unit 602 is read as “process” . . . . Alternatively, the SNS program is a program which causes the computer to execute a “procedure” wherein the “unit” of the SNS providing unit 602 is read as “procedure”. The SNS program may be provided as being recorded on a computer-readable medium or provided as a program product.

The false submission filter program is a program which causes the computer to execute each “process” wherein the “unit” of each of the submission determination unit 603, the event specifying unit 604, the query destination specifying unit 605, the query unit 606, and the result reflecting unit 607 is read as “process” . . . . Alternatively, the false submission filter program is a program which causes the computer to execute each “procedure” wherein the “unit” of each of the submission determination unit 603, the event specifying unit 604, the query destination specifying unit 605, the query unit 606, and the result reflecting unit 607 is read as “procedure”. The false submission filter program may be provided as being recorded on a computer-readable medium or provided as a program product.

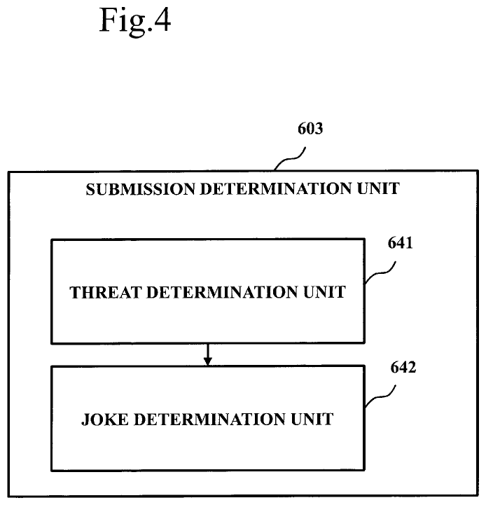

With reference to FIG. 4, the configuration of the submission determination unit 603 is described.

The submission determination unit 603 includes a threat determination unit 641 and a joke determination unit 642.

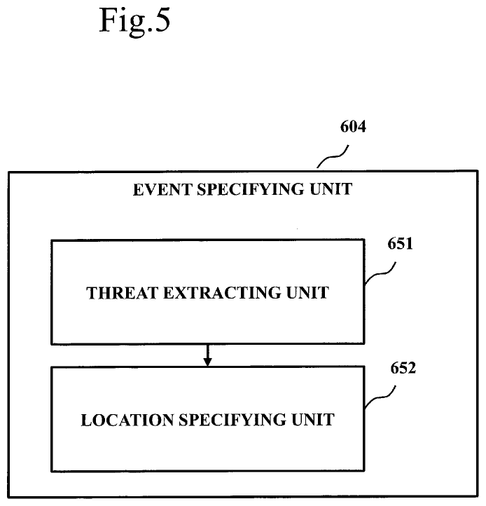

With reference to FIG. 5, the configuration of the event specifying unit 604 is described.

The event specifying unit 604 includes a threat extraction unit 651 and a location specifying unit 652.

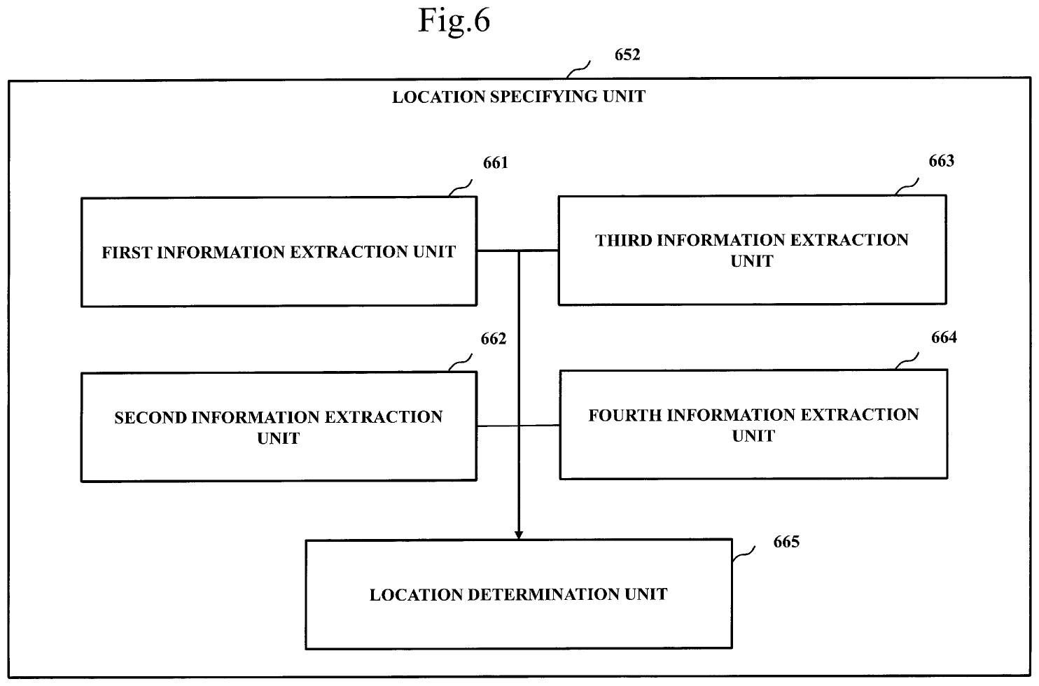

With reference to FIG. 6, the configuration of the location specifying unit 652 is described.

The location specifying unit 652 includes a first information extraction unit 661, a second information extraction unit 662, a third information extraction unit 663, a fourth information extraction unit 664, and a location determination unit 665.

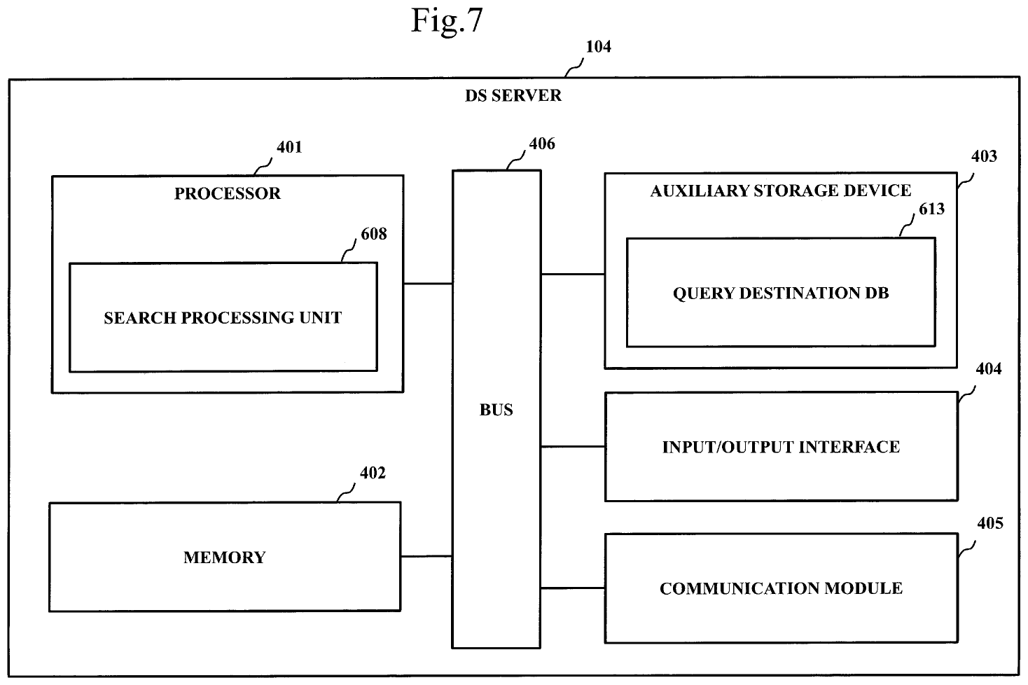

With reference to FIG. 7, the configuration of the DS server 104 according to the present embodiment is described.

The DS server 104 is a computer. The DS server 104 includes a processor 401 and other pieces of hardware such as a memory 402, an auxiliary storage device 403, an input/output interface 404, and a communication module 405. The processor 401 is connected via a bus 406 to the other pieces of hardware to control these other pieces of hardware.

The DS server 104 includes a search processing unit 608 and a query destination database 613. The function of the search processing unit 608 is implemented by software. The query destination database 613 may be constructed on the memory 402, but is constructed in the auxiliary storage device 403 in the present embodiment. The query destination database 613 will be described further below.

The processor 401 is a device which executes a search program. The search program is a program which implements the function of the search processing unit 608.

The processor 401 is, for example, a CPU.

The memory 402 and the auxiliary storage device 403 are devices which store the search program. The memory 402 is, for example, a flash memory or RAM. The auxiliary storage device 403 is, for example, a flash memory or HDD.

The search program is stored in advance in the auxiliary storage device 403. The search program is loaded onto the memory 402, read to the processor 401, and executed by the processor 401. In the auxiliary storage device 403, not only the search program but also an OS is stored. The processor 401 executes the search program while executing the OS.

Note that a part or entire of the search program may be incorporated in the OS.

The input/output interface 404 includes an input interface to which an input device not illustrated is connected and an output interface to which a display not illustrated is connected. The input device is a device to be operated by the user to input data to the search program. The input device is, for example, a mouse, keyboard, or touch panel. The display is a device which displays data outputted from the search program on a screen. The display is, for example, an LCD.

The communication module 405 includes a receiver which receives data inputted to the search program and a transmitter which transmits data outputted from the search program. The communication module 405 is, for example, a communication chip or NIC. The communication module 405 is connected directly or via LAN to the Internet 101.

The DS server 104 may include a plurality of processors which replace the processor 401. The plurality of these processors share execution of the search program. Each processor is, for example, a CPU.

Data, information, signal values, and variable values to be used, processed, or outputted by the search program are stored in the memory 402, the auxiliary storage device 403, or a register or cache memory in the processor 401.

The search program is a program which causes the computer to execute each “process” wherein the “unit” of the search processing unit 608 is read as “process” . . . . Alternatively, the search program is a program which causes the computer to execute each “procedure” wherein the “unit” of the search processing unit 608 is read as “procedure”. The search program may be provided as being recorded on a computer-readable medium or provided as a program product.

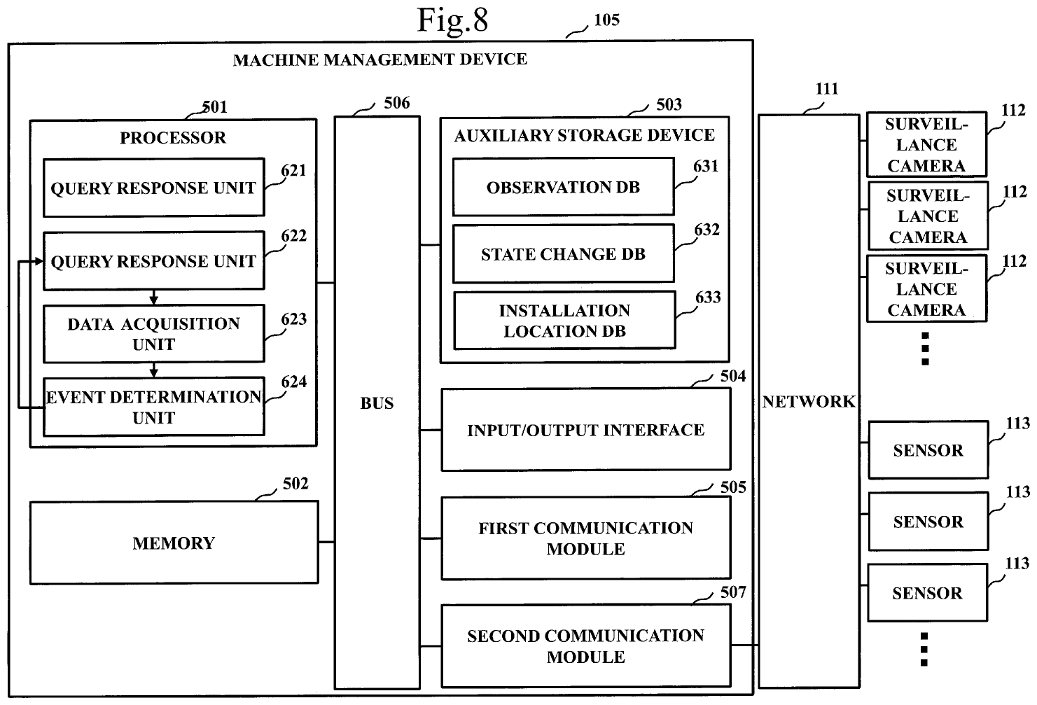

With reference to FIG. 8, the configuration of the machine management device 105 according to the present embodiment is described.

The machine management device 105 is a computer. The machine management device 105 includes a processor 501 and other pieces of hardware such as a memory 502, an auxiliary storage device 503, an input/output interface 504, a first communication module 505, and a second communication module 507. The processor 501 is connected via a bus 506 to the other pieces of hardware to control these other pieces of hardware.

The machine management device 105 includes an observation unit 621, a query response unit 622, a data acquisition unit 623, an event determination unit 624, an observation database 631, a state change database 632, and an installation location database 633. The functions of the observation unit 621, the query response unit 622, the data acquisition unit 623, and the event determination unit 624 are implemented by software. The observation database 631, the state change database 632, and the installation location database 633 may be constructed on the memory 502, but is constructed in the auxiliary storage device 503 in the present embodiment. The observation database 631 is a database which stores and manages observation results of one or more machines as observation data. The state change database 632 and the installation location database 633 will be described further below.

The processor 501 is a device which executes a machine management program. The machine management program is a program which implements the functions of the observation unit 621, the query response unit 622, the data acquisition unit 623, and the event determination unit 624. The processor 501 is, for example, a CPU.

The memory 502 and the auxiliary storage device 503 are devices which store the machine management program. The memory 502 is, for example, a flash memory or RAM. The auxiliary storage device 503 is, for example, a flash memory or HDD.

The machine management program is stored in advance in the auxiliary storage device 503. The machine management program is loaded onto the memory 502, read to the processor 501, and executed by the processor 501. In the auxiliary storage device 503, not only the machine management program but also an OS is stored. The processor 501 executes the machine management program while executing the OS.

Note that a part or entire of the machine management program may be incorporated in the OS.

The input/output interface 504 includes an input interface to which an input device not illustrated is connected and an output interface to which a display not illustrated is connected. The input device is a device to be operated by an administrator of the machine to input data to the machine management program. The input device is, for example, a mouse, keyboard, or touch panel. The display is a device which displays data outputted from the machine management program on a screen. The display is, for example, an LCD.

The first communication module 505 includes a receiver which receives data inputted to the machine management program and a transmitter which transmits data outputted from the machine management program. The first communication module 505 is, for example, a communication chip or NIC. The first communication module 505 is connected directly or via LAN to the Internet 101.

The second communication module 507 includes a receiver which receives data from one or more machines and a transmitter which transmits data to one or more machines. The second communication module 507 is, for example, a communication chip or NIC. The second communication module 507 is connected via a network 111 to one or more machines. In the present embodiment, as one or more machines, there are a plurality of surveillance cameras 112 and a plurality of sensors 113 such as a heat detection sensor, smoke sensor, and water level sensor.

The machine management device 105 may include a plurality of processors which replace the processor 501. The plurality of these processors share execution of the machine management program. Each processor is, for example, a CPU.

Data, information, signal values, and variable values to be used, processed, or outputted by the machine management program are stored in the memory 502, the auxiliary storage device 503, or a register or cache memory in the processor 501.

The machine management program is a program which causes the computer to execute each “process” wherein the “unit” of each of the observation unit 621, the query response unit 622, the data acquisition unit 623, and the event determination unit 624 is read as “process” . . . . Alternatively, the machine management program is a program which causes the computer to execute each “procedure” wherein the “unit” of each of the observation unit 621, the query response unit 622, the data acquisition unit 623, and the event determination unit 624 is read as “procedure”. The machine management program may be provided as being recorded on a computer-readable medium or provided as a program product.

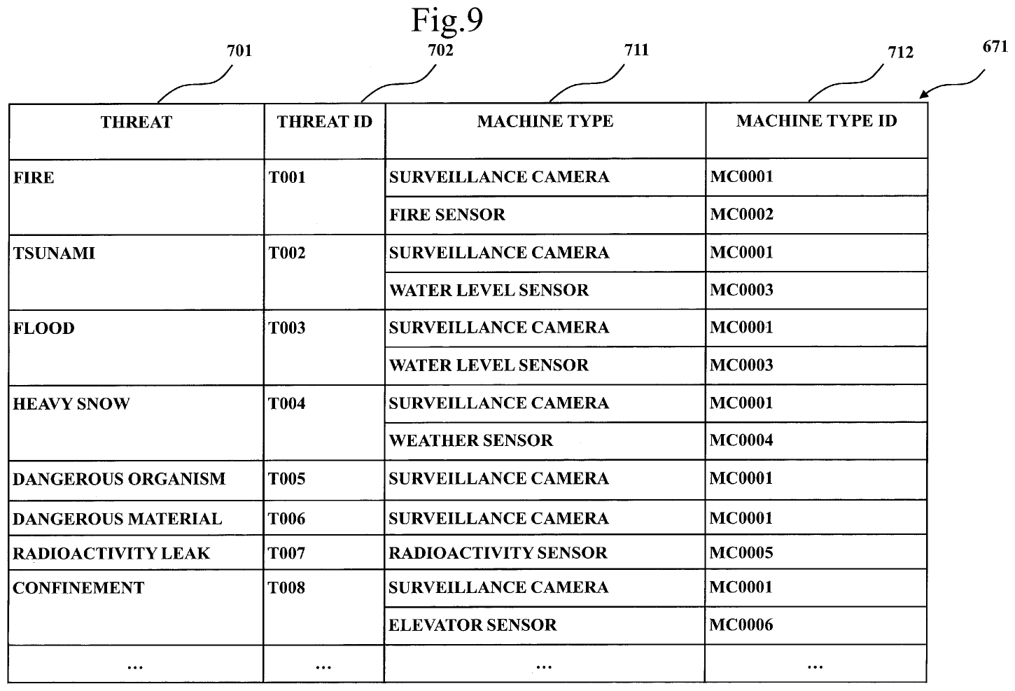

A correspondence table 671 registered in the machine database 612 of the SNS server 103 is illustrated in FIG. 9.

The machine database 612 is a database which stores data specifying a machine type 711 corresponding to a threat 701. Specifically, the machine database 612 is a database in which a correspondence between the threat 701 and the machine type 711 of a machine to be checked is registered as the correspondence table 671. The machine type 711 is information indicating the machine abstracted as any of “surveillance camera”, “fire sensor”, “water level sensor”, and so forth. Fire sensors include a heat detection sensor and a smoke sensor.

The correspondence table 671 of the machine database 612 is formed of at least four items, that is, the threat 701, a threat ID 702, the machine type 711, and a machine type ID 712. “ID” is an abbreviation for Identifier. In the correspondence table 671 of the machine database 612, the machine type ID 712 is registered for each threat ID 702. That is, it is indicated which machine type 711 is to be checked for the threat 701 to allow the presence or absence of occurrence of the threat 701 to be checked. The threat ID 702 is an identifier uniquely assigned to the threat 701. The threat ID 702 is desirably uniform across the world. The machine type ID 712 is an identifier uniquely assigned to the machine type 711. The machine type ID 712 is desirably uniform across the world. The threat 701 and the machine type 711 are convenient for manually managing the correspondence table 671 of the machine database 612, but are not imperative.

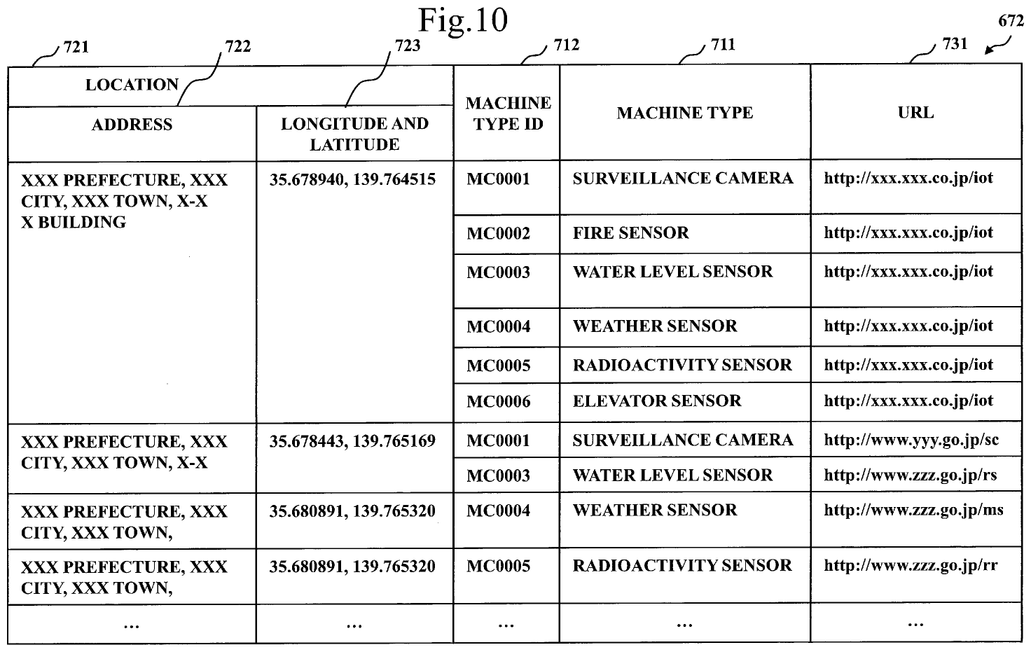

A correspondence table 672 registered in the query destination database 613 of the DS server 104 is illustrated in FIG. 10.

The query destination database 613 is a database which stores data for associating a location 721 being observed by one or more machines and a URL 731 as a query destination of the management subject which manages the one or more machines. Specifically, the query destination database 613 is a database in which a correspondence among the location 721, the machine type 711 of the machine managed by the machine management device 105, and the URL 731 of the query destination is registered as the correspondence table 672. “URL” is an abbreviation for Uniform Resource Locator. The query destination database 613 is desirably managed and maintained by a specific organization as a DNS so that an error or contradiction does not occur in the registered information. “DNS” is an abbreviation for Domain Name System. The location 721 is represented by an address 722 and a longitude and latitude 723. Note that as a query destination of the management subject, a mail address, IP address, or the like may be used in place of the URL 731. “IP” is an abbreviation for Internet Protocol.

The correspondence table 672 of the query destination database 613 is formed of at least five items, that is, the address 722 and the longitude and latitude 723 of the location 721 where the machine is installed, the machine type ID 712, the machine type 711, and the URL 731. The URL 731 is a query destination as to the presence or absence of occurrence of the threat 701 for the machine management device 105 which manages the machine installed at the location 721. In the correspondence table 672 of the query destination database 613, the URL 731 is registered for each of the location 721 and the machine type ID 712. That is, the URL 731 is indicated as a destination for a query about the presence or absence of occurrence of the threat 701 for the specific machine type 711 at the specific location 721. The machine type 711 is convenient for manually managing the correspondence table 672 of the query destination database 613, but is not imperative. In the correspondence table 672 of the query destination database 613, a different URL 731 or the same URL 731 may be registered for each machine type 711 of the machine managed by the machine management device 105.

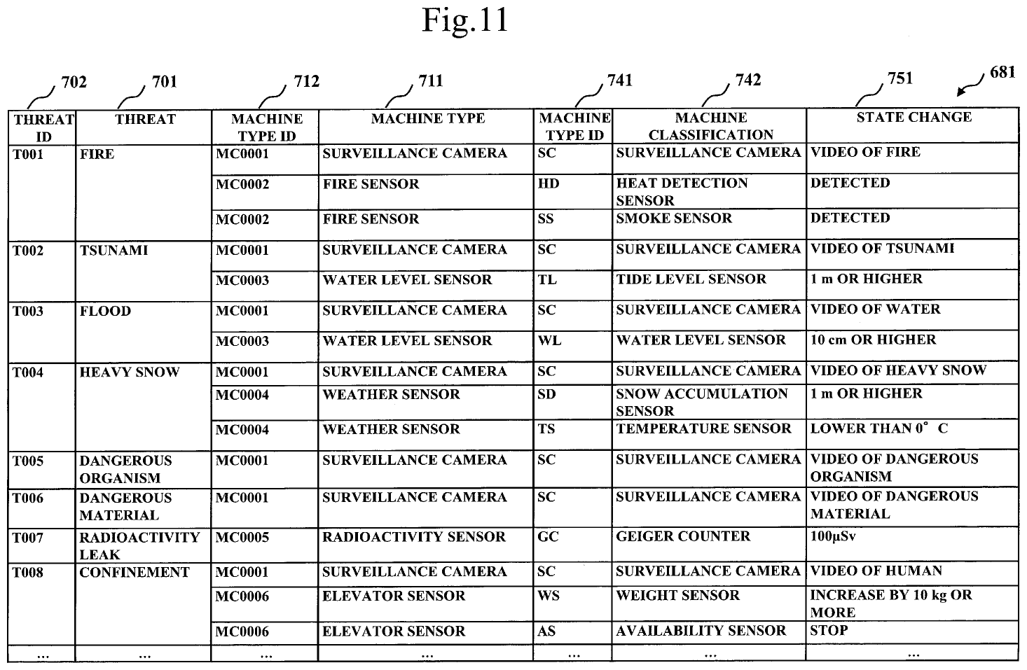

A correspondence table 681 registered in the state change database 632 of the machine management device 105 is illustrated in FIG. 11.

The state change database 632 is a database in which a correspondence among the threat 701, the machine type 711, a machine classification 742, and a state change 751 is registered as the correspondence table 681.

The correspondence table 681 of the state change database 632 is formed of at least seven items, that is, the threat ID 702, the threat 701, the machine type ID 712, the machine type 711, a machine classification ID 741, the machine classification 742, and the state change 751. In the correspondence table 681 of the state change database 632, the machine classification ID 741 and the state change 751 of the machine at the time of occurrence of the threat 701 are registered for each threat ID 702. That is, it is indicated which state change 751 of which machine classification 742 is to be checked for the threat 701 to allow the presence or absence of occurrence of the threat 701 to be checked. The machine classification ID 741 is an identifier uniquely assigned to the machine classification 742. If indicating the same corresponding machine classification 742, each machine classification ID 741 may be different or the same for each machine management device 105. The machine classification 742 indicates a type of machine that is more detailed than the machine type 711, such as any of “surveillance camera”, “heat detection sensor”, “smoke sensor”, and “water level sensor”. The state change 751 is a change of the state to be checked. If the registered state change 751 is occurring in the machine, this means that the threat 701 is occurring. By varying the state change 751 for each machine management device 105, the state change 751 in accordance with the environment of the machine management device 105 can be set. In the correspondence table 681 of the state change database 632, what is only required to be registered is: the threat 701 that can be checked by the machine management device 105; the machine type 711, the machine type ID 712, the machine classification 742, and the machine classification ID 741 of each machine managed by the machine management device 105; and the state change 751 for the machine. The machine type ID 712 and the machine type 711 may be omitted. The threat 701, the machine type 711, and the machine classification 742 are convenient for manually managing the correspondence table 681 of the state change database 632, but are not imperative.

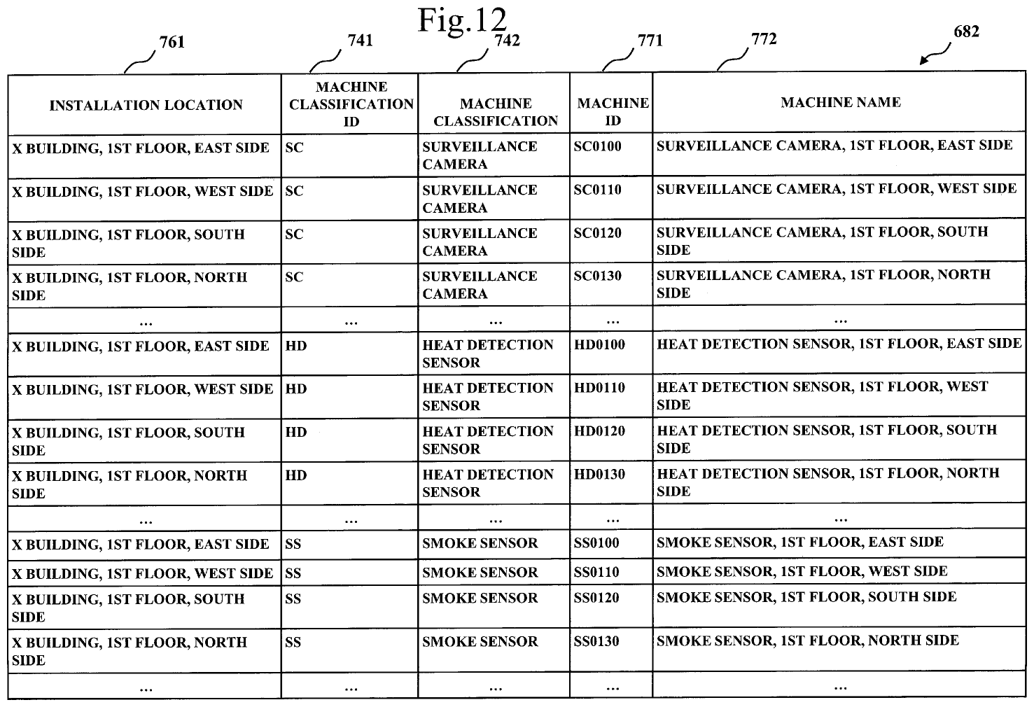

A correspondence table 682 registered in the installation location database 633 of the machine management device 105 is illustrated in FIG. 12.

The installation location database 633 is a database in which a correspondence among an installation location 761, the machine classification 742, and a machine name 772 is registered as the correspondence table 682.

The correspondence table 682 of the installation location database 633 is formed of at least five items, that is, the installation location 761, the machine classification ID 741, the machine classification 742, a machine ID 771, and the machine name 772. In the correspondence table 682 of the installation location database 633, the machine ID 771 is registered for each of the installation location 761 and the machine classification ID 741. That is, a machine corresponding to a specific machine classification 742 of a specific installation location 761 is indicated. The installation location 761 is a location where the machine is installed. The machine ID 771 is an identifier uniquely assigned to the machine in the machine management device 105. The machine ID 771 is provided to the machine when the machine management device 105 stores the observation result of the machine. The surveillance camera 112 and the sensor 113 each have a unique machine ID 771. In place of the machine ID 771, a MAC address or IP address may be used. “MAC” is an abbreviation for Media Access Control. The machine name 772 is a name assigned to the machine. In the correspondence table 682 of the installation location database 633, only the installation location 761, the machine classification ID 741, the machine classification 742, a machine ID 771, and the machine name 772 of each machine managed by the machine management device 105 are registered. The machine classification 742 and the machine name 772 are convenient for manually managing the correspondence table 682 of the installation location database 633, but are not imperative. By using the machine ID 771 registered in the correspondence table 682 of the installation location database 633, the machine management device 105 can acquire observation data of a specific machine stored in the observation database 631.

### Description of Operation

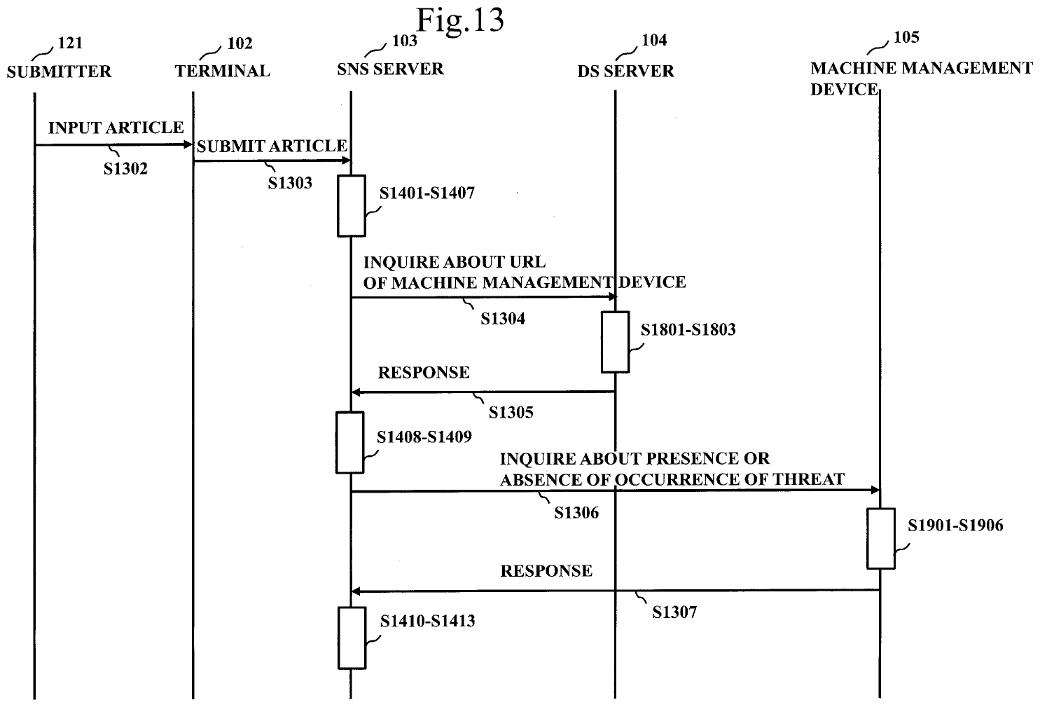

With reference to FIG. 1 to FIG. 12 as well as FIG. 13 to FIG. 18, the operation of the false submission filter system 100 according to the present embodiment is described. The operation of the false submission filter system 100 corresponds to a false submission filter method according to the present embodiment.

At step S1302, the submission viewing unit 601 of the terminal 102 accepts an input of a submitted article from a submitter 121 as a user via the input/output interface 204. At step S1303, the submission viewing unit 601 transmits the submitted article via the communication module 205 to the SNS server 103. As a specific example, it is assumed that the submitter 121 submits an article “A fire at X building in XXX town, danger!” to stir up fears of others to SNS. In this example, it is assumed that an image and GPS information of a submission location are affixed to the submitted article. It is assumed that GPS information of an image-taken location is included in the image. “GPS” is an abbreviation for Global Positioning System.

At step S1401, the SNS providing unit 602 of the SNS server 103 receives the submitted article from the submitter 121 via the communication module 305. At step S1402, the SNS providing unit 602 stores the submitted article in the submission database 611. At step S1403, the submission determination unit 603 of the SNS server 103 determines whether the submitted article is an article to stir up fears of others and whether the submitted article is clearly a joke. Details of the process at step S1403 will be described further below. At step S1404, a branch process in accordance with the determination results at step S1403 is performed. When it is determined at step S1403 that the submitted article is not an article to stir up fears of others or that it is an article to stir up fears of others but is clearly a joke, the process flow ends. When it is determined at step S1403 that the submitted article is an article to stir up fears of others and is not clearly a joke, a process at step S1405 is performed.

At step S1405, the event specifying unit 604 of the SNS server 103 specifies, from the submitted article, the threat 701 as a source of fear and the location 721 of occurrence of the threat 701. In the present example, the threat 701 is “fire”. The location 721 of occurrence of the threat 701 is “XXX prefecture, XXX city, XXX town, X-X, X building”. Details of the process at step S1405 will be described further below.

At step S1406, the query destination specifying unit 605 of the SNS server 103 searches the correspondence table 671 of the machine database 612 based on the threat 701 specified by the event specifying unit 604, and specifies the threat ID 702 corresponding to the threat 701 and the machine type ID 712 of a machine to be checked. In the present example, for “fire” as the threat 701, the threat ID 702 is “T001” and the machine type IDs 712 of machines to be checked are “MC0001” corresponding to “surveillance camera” and “MC0002” corresponding to “fire sensor”.

At step S1304 and step S1407, the query destination specifying unit 605 transmits, via the communication module 305 to the DS server 104, the location 721 of occurrence of the threat 701 specified by the event specifying unit 604 and the machine type IDs 712 of the machines to be checked, and inquires about the URL 731 of the machine management device 105 as a query destination. In the present example, the query destination specifying unit 605 transmits “XXX prefecture, XXX city, XXX town, X-X, X building” as the location 721 of occurrence of the threat 701 and “MC0001” and “MC0002” as the machine type IDs 712 to the DS server 104.

At step S1801, the search processing unit 608 of the DS server 104 receives the query from the SNS server 103 via the communication module 405. At step S1802, from the location 721 of occurrence of the threat 701 and the machine type IDs 712 indicated by the received query, the search processing unit 608 searches the correspondence table 672 of the query destination database 613, and specifies the URL 731 of the machine management device 105 as the query destination. In the present example, the URL 731 of the machine management device 105 which manages both of “surveillance camera” and “fire sensor” respectively corresponding to “MC0001” and “MC0002” as the machine type IDs 712 at “XXX prefecture, XXX city, XXX town, X-X, X building” as the location 721 of occurrence of the threat 701 is “http://xxx.xxx.co.jp/iot”. Note that if the machine management device 105 at “XXX prefecture, XXX city, XXX town, X-X, X building” is not present, the URL 731 of the machine management device 105 which manages a machine at “XXX prefecture, XXX city, XXX town, X-X” may be specified.

At step S1305 and step S1803, the search processing unit 608 transmits the URL 731 of the specified machine management device 105 via the communication module 405 to the SNS server 103. In the present example, the search processing unit 608 transmits “http://xxx.xxx.co.jp/iot” as the URL 731 of the machine management device 105.

At step S1408, the query destination specifying unit 605 of the SNS server 103 receives a response from the DS server 104 via the communication module 305. In the present example, the query destination specifying unit 605 receives a response indicating that the URL 731 of the machine management device 105 as a query destination is “http://xxx.xxx.co.jp/iot” for both.

At step S1306 and step S1409, the query unit 606 of the SNS server 103 transmits the threat ID 702, the location 721 of occurrence of the threat 701, and a time when the article was submitted as a time of occurrence of the threat 701, via the communication module 305 to the URL 731 of the machine management device 105 as the query destination specified by the query destination specifying unit 605, and inquires about the presence or absence of occurrence of the threat 701. Note that upon request from the machine management device 105, the query unit 606 may also transmit, to the machine management device 105, the machine type IDs 712 of the machines to be checked as parameters of the URL 731 or the like. If there are a plurality of machine management devices 105 as query destinations, a query is directed to all of the machine management devices 105. In the present example, the query unit 606 transmits “T001” as the threat ID 702 and “XXX prefecture, XXX city, XXX town, X-X, X building” as the location 721 of occurrence of the threat 701 as well as the time of occurrence of the threat 701 to “http://xxx.xxx.co.jp/iot”, and inquires about the presence or absence of occurrence of “fire”. As required, the query unit 606 may transmit “MC0001” and “MC0002” as machine type IDs 712.

At step S2001, the observation unit 621 of the machine management device 105 collects observation data always in real time from the surveillance camera 112 and the sensor 113 connected to the network 111 of the management subject via the second communication module 507. The observation unit 621 stores the observation data into the observation database 631. When storing the observation data into the observation database 631, the observation unit 621 also stores the machine ID 771 of the surveillance camera 112 or the sensor 113 as a collection source machine and its observation time. The process at step S2001 is semipermanently repeated until the machine management device 105 stops.

At step S1901, the query response unit 622 of the machine management device 105 receives, via the first communication module 505, the query about the presence or absence of occurrence of the threat 701 from the SNS server 103. The query about the presence or absence of occurrence of the threat 701 includes the threat ID 702, the location 721 of occurrence of the threat 701, and the time of occurrence of the threat 701. In the present example, as the query about the presence or absence of occurrence of the threat 701, the machine management device 105 at “XXX prefecture, XXX city, XXX town, X-X, X building” receives “T001” as the threat ID 702 and “XXX prefecture, XXX city, XXX town, X-X, X building” as the location 721 of occurrence of the threat 701 as well as the time of occurrence of the threat 701. Note that, as required, the machine management device 105 may receive “MC0001” and “MC0002” as the machine type IDs 712.

At step S1902, the data acquisition unit 623 of the machine management device 105 extracts the threat ID 702, the location 721 of occurrence of the threat 701, and the time of occurrence of the threat 701 from the query about the presence or absence of occurrence of the threat 701 received by the query response unit 622. If the machine type IDs 712 are also transmitted as parameters of the URL 731 or the like, the data acquisition unit 623 also extracts the machine type IDs 712. Based on the threat ID 702 extracted from the query about the presence or absence of occurrence of the threat 701, the data acquisition unit 623 acquires, from the correspondence table 681 of the state change database 632, the machine classification IDs 741 of the machines to be checked and the state changes 751 of the machines at the time of occurrence of the threat 701. Note that the data acquisition unit 623 may also use the machine type IDs 712 as required together with the threat ID 702 to acquire the machine classification IDs 741 of the machines to be checked and the state changes 751 of the machines at the time of occurrence of the threat 701. In the present example, the machine classification IDs 741 of the machines to be checked for the threat ID 702 “T001” corresponding to “fire” are “SC” corresponding to “surveillance camera”, “HD” corresponding to “heat detection sensor”, and “SS” corresponding to “smoke detection sensor”. At “surveillance camera”, when “video of fire” shows up, this means that “fire” is occurring. At “heat detection sensor”, when heat is “detected”, this means that “fire” is occurring. At “smoke detection sensor”, when smoke is “detected”, this means that “fire” is occurring.

At step S1903, based on the location 721 of occurrence extracted from the query about the presence or absence of occurrence of the threat 701 and the machine classification IDs 741 acquired from the state change database 632, the data acquisition unit 623 acquires the machine IDs 771 of the machines to be checked from the correspondence table 682 of the installation location database 633. In the present example, since the floor where the threat 701 is occurring is not indicated, the machine IDs 771 relevant to “SC”, “HD”, and “SS” of “XXX prefecture, XXX city, XXX town, X-X, X building” are “SC0100”, “SC0110”, “SC0120”, “SC0130”, . . . ; “HD0100”, “HD0110”, “HD0120”, “HD0130”, . . . ; and “SS0100”, “SS0110”, “SS0120”, “SS0130”,

At step S1904, based on the acquired machine IDs 771 and the time of occurrence extracted from the query about the presence or absence of occurrence of the threat 701, the data acquisition unit 623 acquires, from the observation database 631, observation data around the time of occurrence of the threat 701. In the present example, the data acquisition unit 623 acquires, from the observation database 631, observation data of the surveillance camera 112 and the sensor 113 corresponding to “SC0100”, “SC0110”, “SC0120”, “SC0130”, . . . ; “HD0100”, “HD0110”, “HD0120”, “HD0130”, . . . ; and “SS0100”, “SS0110”, “SS0120”, “SS0130”, . . . around the time of occurrence of the threat 701. “Around the time of occurrence” is, for example, from one hour before the time of occurrence to the time of occurrence.

At step S1905, the event determination unit 624 of the machine management device 105 analyzes the observation data acquired by the data acquisition unit 623 from the observation database 631 to determine whether the state change 751 of each machine at the time of occurrence of the threat 701 is occurring. In the observation data, when the state change 751 of the machine occurs, this means that the threat 701 is occurring. When the state change 751 is not occurring, this means that the threat is not occurring. When the observation data is image data acquired from the surveillance camera 112, the event determination unit 624 uses AI technology such as image recognition technology or machine learning, to determine whether the state change 751 is occurring. “AI” is an abbreviation for Artificial Intelligence. When the presence or absence of occurrence of the threat 701 is determined from the observation data of a plurality of machines corresponding to different machine classification IDs 741, which determination criterion is to be used may be freely set by the administrator of the machine management device 105. For example, as for one machine classification ID 741, if the state change 751 is occurring in the observation data from the machine corresponding to that machine classification ID 741, it may be determined that the threat 701 is occurring. Alternatively, as for all machine classification IDs 741, it may be determined that the threat 701 is occurring only if the state change 751 is occurring in the observation data from the machine corresponding to each machine classification ID 741. In the present example, if “video of fire” shows up in any of image data “SC0100”, “SC0110”, “SC0120”, “SC0130”, . . . ; heat is “detected” in any of data “HD0100”, “HD0110”, “HD0120”, “HD0130”, . . . ; and smoke is “detected” in any of data “SS0100”, “SS0110”, “SS0120”, “SS0130”, . . . , it is determined that “fire” is occurring.

At step S1307 and step S1906, the query response unit 622 transmits, via the first communication module 505, the determination result as to the presence or absence of occurrence of the threat 701 by the event determination unit 624 to the SNS server 103 as a response to the query about the presence or absence of occurrence of the threat 701. For example, the query response unit 622 transmits “Yes” if the threat 701 is occurring, and transmits “No” if the threat 701 is not occurring.

At step S1410, the query unit 606 of the SNS server 103 receives, via the communication module 305 from all machine management devices 105 as query destinations, the determination result as to the presence or absence of occurrence of the threat 701. For example, the query unit 606 receives “Yes” if the submitted article is true and the threat 701 is occurring, and receives “No” if the submitted article is false and the threat 701 is not occurring.

At step S1411, based on the determination result as to the presence or absence of occurrence of the threat 701 received by the query unit 606, the result reflecting unit 607 of the SNS server 103 determines whether the submitted article is true or false. For example, if “Yes” has been received, it is determined that the threat is occurring and the submitted article is true. On the other hand, if “No” has been received, it is determined that the threat is not occurring and the submitted article is false. The criteria for true/false determination when a query is transmitted to a plurality of machine management devices 105 may be freely set by the administrator of the SNS server 103. For example, if at least one “Yes” is present, it may be determined that the submitted article is true. Alternatively, if “Yes” is present by a majority, it may be determined that the submitted article is true. At step S1412, a branch process in accordance with the determination result at step S1411 is performed. When it is determined at step S1411 that the submitted article is true, the process flow ends. When it is determined at step S1411 that the submitted article is false, a process at step S1413 is performed.

At step S1413, the result reflecting unit 607 reflects the true/false determination result in the submitted article by providing a mark indicating that it is false to the submitted article or deleting the submitted article. The SNS providing unit 602 of the SNS server 103 distributes the submitted article with the true/false determination result reflected therein via the communication module 205 to the terminal 102. Note that the SNS providing unit 602 may distribute the submitted article when the submitted article is stored at step S1402 and redistribute the submitted article as required when the true/false determination result is reflected. The submission viewing unit 601 of the terminal 102 receives the article distributed from the SNS server 103 via the communication module 205 to allow the submitter 121 to view the article.

As has been described in the foregoing, in the present embodiment, the event specifying unit 604 analyzes the contents of the submission providing notification about the occurrence of an event and specifies the location 721 of occurrence of the event. Specifically, the event specifying unit 604 uses at least either of AI technology and natural language processing technology to specify the location 721 of occurrence of the event as detailed as possible from at least either of text and the image included in the submission. The query destination specifying unit 605 searches the query destination database 613 to specify the query destination corresponding to the location 721 specified by the event specifying unit 604. The query unit 606 transmits a request for checking the presence or absence of occurrence of the event from the observation result of one or more machines to the query destination specified by the query destination specifying unit 605.

The query response unit 622 of the machine management device 105 receives the request transmitted from the query unit 606. In response to the request received by the query response unit 622, the data acquisition unit 623 of the machine management device 105 acquires the observation result of one or more machines. The event determination unit 624 of the machine management device 105 checks the presence or absence of occurrence of the event from the observation result acquired by the data acquisition unit 623. The query response unit 622 transmits a response indicating the check result of the event determination unit 624.

The query unit 606 receives the response to the request. The result reflecting unit 607 determines whether the contents of the submission are true or false from the check result indicated by the response received by the query unit 606. The result reflecting unit 607 performs a process in accordance with the determination result on the submission.

In the present embodiment, the event specifying unit 604 analyses the contents of the submission to further specify the threat 701 occurring as an event. The query unit 606 searches the machine database 612 and specifies the machine type 711 corresponding to the threat 701 specified by the event specifying unit 604. The query unit 606 causes information about the specified machine type 711 to be included in the request, and transmits a request for checking the presence or absence of occurrence of the event from the observation result of the machine relevant to the specified machine type 711.

In the present embodiment, the submission time is regarded as the time of occurrence of the event. The event specifying unit 604 may analyze the contents of the submission to further specify the time of occurrence of the event. Specifically, the event specifying unit 604 may use at least either of AI technology and natural language processing technology to specify the time of occurrence of the event as detailed as possible from text included in the submission. The query unit 606 may cause information about the time specified by the event specifying unit 604 to be included in the request, and transmit a request for checking the presence or absence of occurrence of the event at the time specified by the event specifying unit 604 from the observation result of one or more machines.

The event the location 721 of occurrence of which is specified by the event specifying unit 604 is the threat 701 in the present embodiment, but may be any event and, for example, may be an event in which the submitter 121 has seen a specific person, or a movable body such as a specific vehicle.

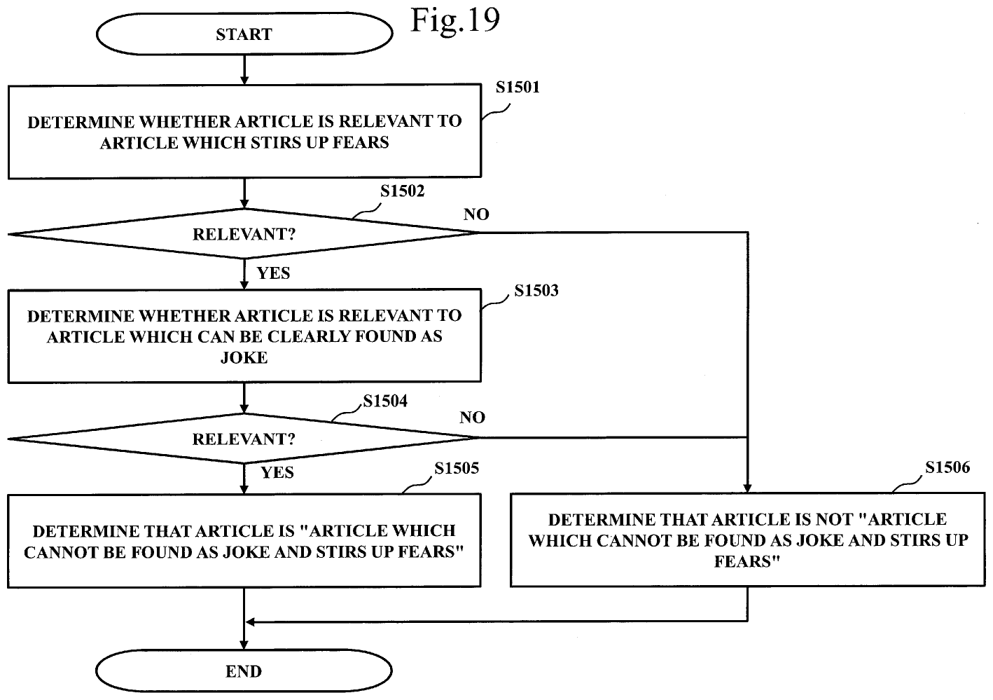

In the following, with reference mainly to FIG. 19, details of the process at step S1403 are described.

As described above, at step S1403, the submission determination unit 603 of the SNS server 103 determines whether the submitted article is an article to stir up fears of others and whether the submitted article is clearly a joke.

At step S1501, the threat determination unit 641 of the submission determination unit 603 uses AI technology and natural language processing technology to determine whether the submitted article is an article to stir up fears. At step S1502, a branch process in accordance with the determination result at step S1501 is performed. When it is determined at step S1501 that the submitted article is an article to stir up fears, a process at step S1503 is performed. When it is determined at step S1501 that the submitted article is not an article to stir up fears, a process at step S1506 is performed. In the present example, since text “fire . . . danger!” is included in the submitted article, the threat determination unit 641 determines that the submitted article is an article to stir up fears.

At step S1503, the joke determination unit 642 of the submission determination unit 603 uses AI technology and natural language processing technology to determine whether the submitted article can be clearly found as a joke. Specifically, the joke determination unit 642 determines whether the submitted article can be clearly found as a joke from the writing style of the submitted article, the usage of an emoji, the usage of a symbol, and so forth. At step S1504, a branch process in accordance with the determination result at step S1503 is performed. When it is determined at step S1503 that the submitted article is not an article which can be found as a joke, a process at step S1505 is performed. When it is determined at step S1503 that the submitted article can be clearly found as a joke, a process at step S1506 is performed. In the present example, an emoji, symbol, or the like implying a joke such as “(laugh)” or “(\hat{ }\hat{ })” is not included in the submitted article, an exclamation mark “!” is used, and the writing style is serious. Thus, the joke determination unit 642 determines that the submitted article cannot be clearly found as a joke.

At step S1505, the joke determination unit 642 outputs the determination result that the submitted article is “an article which cannot be found as a joke and stirs up fears”. On the other hand, at step S1506, the threat determination unit 641 or the joke determination unit 642 outputs the determination result that the submitted article is not “an article which cannot be found as a joke and stirs up fears”.

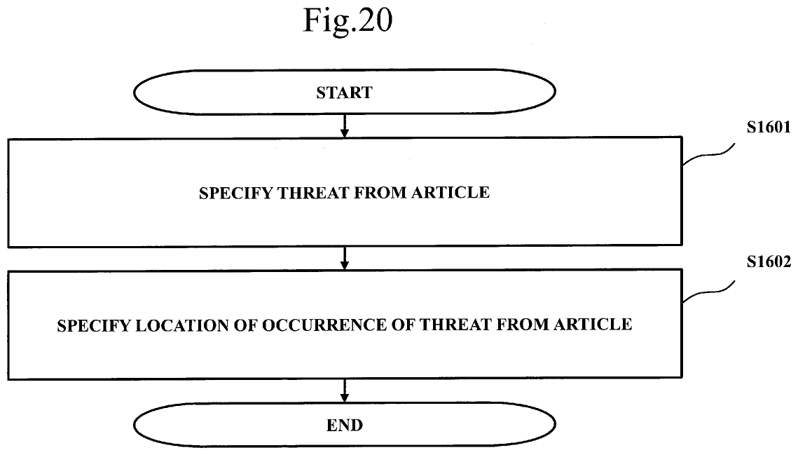

In the following, with reference mainly to FIG. 20, details of the process at step S1405 are described.

As described above, at step S1405, the event specifying unit 604 of the SNS server 103 specifies the threat 701 as a source of fear and the location 721 of occurrence of the threat 701 from the submitted article.

At step S1601, the threat extraction unit 651 of the event specifying unit 604 uses AI technology and natural language processing technology to extract an event as a source of fear stirred up by the submitted article from the submitted article. The threat extraction unit 651 specifies, from a synonym dictionary or the like, to which of the threats 701 registered in the correspondence table 671 of the machine database 612 the extracted event is relevant. In the present example, the threat extraction unit 651 recognizes from the submitted article that the event as a source of fear is “fire”. The threat extraction unit 651 determines, from the synonym dictionary or the like, that “fire” is relevant to “fire” among the threats 701 registered in the correspondence table 671 of the machine database 612.

At step S1602, the location specifying unit 652 of the event specifying unit 604 specifies, from the text of the submitted article and the image attached to the submitted article, the location 721 of occurrence of the threat 701.

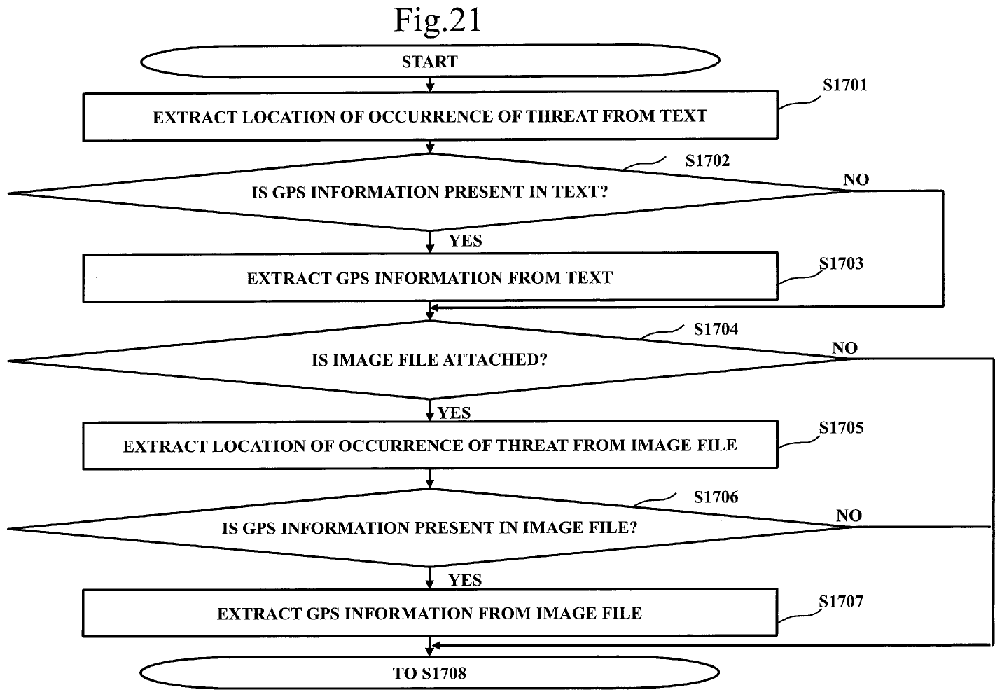

With reference mainly to FIG. 21 to FIG. 23, details of the process at step S1602 are described.

At step S1701, the first information extraction unit 661 of the location specifying unit 652 uses AI technology and natural language processing technology and, furthermore, a search site on the Internet 101 and so forth to extract, from the text of the submitted article, the location 721 of occurrence of the threat 701 as detailed as possible. At step S1702, the second information extraction unit 662 of the location specifying unit 652 uses regular expression search technology and so forth to check whether GPS information is inserted in the text of the submitted article by operation of the submitter 121. When GPS information is inserted, at step S1703, the second information extraction unit 662 extracts the GPS information inserted in the text of the submitted article. When GPS information is not inserted, the second information extraction unit 662 does nothing.

At step S1704, the third information extraction unit 663 and the fourth information extraction unit 664 of the location specifying unit 652 check whether an image file is attached to the submitted article. When an image file is not attached, the third information extraction unit 663 and the fourth information extraction unit 664 do nothing. When an image file is attached, at step S1705, the third information extraction unit 663 uses AI technology, an image search site on the Internet 101, and so forth to extract the location 721 where the threat 701 is occurring from the image file attached to the submitted article. At step S1706, the fourth information extraction unit 664 uses image file format processing technology to check whether GPS information is inserted in the image file at the time of image-taking. When GPS information is inserted in the image file, at step S1707, the fourth information extraction unit 664 uses image file format processing technology to extract the GPS information inserted in the image file. When GPS information is not inserted in the image file, the fourth information extraction unit 664 does nothing.

At step S1708, the location determination unit 665 of the location specifying unit 652 checks whether the first information extraction unit 661 has extracted the location 721 of occurrence of the threat 701 from the text of the submitted article. If the location 721 of occurrence of the threat 701 has been extracted from the text of the submitted article, the location determination unit 665 checks at step S1709 whether the fourth information extraction unit 664 has extracted the GPS information inserted in the image file. If the GPS information inserted in the image file has not been extracted, the location determination unit 665 determines at step S1710 the location 721 extracted from the text of the submitted article as the location 721 of occurrence of the threat 701, and ends the process.

If the GPS information inserted in the image file has been extracted, the location determination unit 665 checks at step S1711 whether the location 721 of occurrence of the threat 701 extracted from the text of the submitted article and the GPS information extracted from the image file match. Specifically, the location determination unit 665 uses a search site on the Internet 101 or the like to specify the location 721 where the threat 701 is occurring from the GPS information extracted from the image file. The location determination unit 665 checks whether the specified location 721 matches the location 721 of occurrence of the threat 701 extracted from the text of the submitted article. Note that the location determination unit 665 may use a search site on the Internet 101 or the like to acquire GPS information corresponding to the location 721 of occurrence of the threat 701 extracted from the text of the submitted article and check whether the acquired GPS information matches the GPS information extracted from the image file.

When the location 721 of occurrence of the threat 701 extracted from the text of the submitted article and the GPS information extracted from the image file match, the location determination unit 665 determines at step S1712 a position indicated by the GPS information extracted from the image file as the location 721 of occurrence of the threat 701, and ends the process. On the other hand, when the location 721 of occurrence of the threat 701 extracted from the text of the submitted article and the GPS information extracted from the image file do not match, the location determination unit 665 determines at step S1713 that the submitted article is false, and ends the process.

If the location 721 of occurrence of the threat 701 has not been extracted from the text of the submitted article, the location determination unit 665 checks at step S1714 whether the fourth information extraction unit 664 has extracted the GPS information inserted in the image file. If the GPS information inserted in the image file has been extracted, the location determination unit 665 determines at step S1715 the position indicated by the GPS information extracted from the image file as the location 721 of occurrence of the threat 701, and ends the process.

If the GPS information inserted in the image file has not been extracted, the location determination unit 665 checks at step S1716 whether the third information extraction unit 663 has extracted the location 721 of occurrence of the threat 701 from the image file. If the location 721 of occurrence of the threat 701 has been extracted from the image file, the location determination unit 665 determines at step S1717 the location 721 extracted from the image file as the location 721 of occurrence of the threat 701, and ends the process.

If the location 721 of occurrence of the threat 701 has been not extracted from the image file, the location determination unit 665 checks at step S1718 whether the second information extraction unit 662 has extracted the GPS information inserted in the text. If the GPS information inserted in the text has been extracted, the location determination unit 665 determines at step S1719 the position indicated by the GPS information extracted from the text as the location 721 of occurrence of the threat 701, and ends the process. If the GPS information inserted in the text has not been extracted, the location determination unit 665 determines at step S1720 that it is impossible to specify the location 721 of occurrence of the threat 701 and the submitted article is false, and ends the process.

As has been described in the foregoing, in the present embodiment, the event specifying unit 604 specifies the location 721 of occurrence of the event from both of the text and the image included in the submission. If different locations 721 are specified by the event specifying unit 604 from the text and the image, the result reflecting unit 607 determines that the contents of the submission are false. If different locations 721 are specified by the event specifying unit 604 from the text and the image, transmission of a request by the query unit 606 is omitted.

To specify the location 721 of occurrence of the event from the image, the event specifying unit 604 refers to position information added to the image to specify the location 721 of occurrence of the event. The position information referred to is GPS information in the present information, but may be any position information and, for example, may be information representing the address 722.

### Description of Effects of Embodiment

In the present embodiment, since a work of checking whether the contents of the submission are correct or not from the observation result of the machine is performed by the management subject managing the machine, the observation result of the machine can be handled as secret information. Since the query destination of the management subject is selected based on the result of analyzing the contents of the submission, a query can be quickly made. Therefore, it is possible to perform both of quickly taking measures against false submission by determining whether the contents of the submission are true or false from the observation result of the machine and handling the observation result of the machine as secret information.

In the present embodiment, the SNS server 103 as a subject which checks whether the submitted article is true or false specifies query destinations corresponding to the threat 701 and the location 721 of occurrence of the threat 701. The SNS server 103 inquires of the machine management device 105 as the management subject of the machine about the presence or absence of occurrence of the threat 701. By checking the state change 751 of the machine at the location 721 of occurrence, the machine management device 105 determines the presence or absence of occurrence of the threat 701 and makes a response. This allows the SNS server 103 to check whether the threat 701 is occurring at the location specified as the location 721 of occurrence of the threat 701 and reflect the check result in the submitted article. Therefore, the false submitted article can be automatically and instantaneously deleted, or it can be displayed that the submitted article is a false article. As a result, it is possible to automatically prevent the false submitted article from being spread by readers motivated by fears and a social panic from being caused. Furthermore, the observation data of the surveillance camera 112 and the sensor 113 is handled as secret information of the management subject, and is not leaked outside the management subject.

According to the present embodiment, based on the observation data acquired by the machine in the real world, it is possible to automatically determine whether an article or news submitted into cyberspace is true or false. Specifically, it is possible to automatically and instantaneously determine whether the submitted article in SNS is true or false.

In the present embodiment, for a submitted article which stirs up fears to entrap others into anxiety and cause a panic, it is possible to automatically and instantaneously determine whether the contents of the article is true or false based on surveillance information from the surveillance camera 112 and the sensor 113 connected via IoT technology. “IoT” is an abbreviation for Internet of Things. When the contents of the article are false, the submitted article is automatically deleted, or it can be displayed that the submitted article is a false article. Furthermore, in the present embodiment, the surveillance information from the surveillance camera 112 and the sensor 113 can be handled as secret information of an individual or an organization such as a company. That is, the surveillance information can be prevented from going out to an individual or organization different from an individual or organization such as a company which manages the surveillance camera 112 and the sensor 113. This is because the SNS server 103 as a subject which checks whether the submitted article is true or false inquires of the machine management device 105 as a subject which manages the surveillance camera 112 and the sensor 113 about the presence or absence of occurrence of the event and receives only the presence or absence of occurrence of the event as a query result.

### Other Configurations

As a modification example of the present embodiment, the DS server 104 may be unified into the SNS server 103.

In the present embodiment, the function of the submission viewing unit 601 of the terminal 102 is implemented by software. As a modification example, the function of the submission viewing unit 601 may be implemented by hardware. That is, the terminal 102 may include dedicated hardware which implements the function of the submission viewing unit 601. This dedicated hardware is, for example, a single circuit, composite circuit, programmed processor, parallel-programmed processor, logic IC, GA, FPGA, or ASIC. “IC” is an abbreviation for Integrated Circuit. “GA” is an abbreviation for Gate Array. “FPGA” is an abbreviation for Field-Programmable Gate Array. “ASIC” is an abbreviation for Application Specific Integrated Circuit.

As another modification example, the function of the submission viewing unit 601 may be implemented by a combination of software and hardware. That is, the function of the submission viewing unit 601 may be partially implemented by dedicated hardware and the rest may be implemented by software.

The processor 201 and dedicated hardware are both processing circuits. That is, irrespective of being implemented by any of software, hardware, and a combination of software and hardware, the function of the submission viewing unit 601 is exerted by the processing circuits.

In the present embodiment, the functions of the SNS providing unit 602, the submission determination unit 603, the event specifying unit 604, the query destination specifying unit 605, the query unit 606, and the result reflecting unit 607 of the SNS server 103 are implemented by software. As a modification example, the functions of the SNS providing unit 602, the submission determination unit 603, the event specifying unit 604, the query destination specifying unit 605, the query unit 606, and the result reflecting unit 607 may be implemented by hardware. That is, the SNS server 103 may include dedicated hardware which implements the functions of the SNS providing unit 602, the submission determination unit 603, the event specifying unit 604, the query destination specifying unit 605, the query unit 606, and the result reflecting unit 607. This dedicated hardware is, for example, a single circuit, composite circuit, programmed processor, parallel-programmed processor, logic IC, GA, FPGA, or ASIC.

As another modification example, the functions of the SNS providing unit 602, the submission determination unit 603, the event specifying unit 604, the query destination specifying unit 605, the query unit 606, and the result reflecting unit 607 may be implemented by a combination of software and hardware. That is, the functions of the SNS providing unit 602, the submission determination unit 603, the event specifying unit 604, the query destination specifying unit 605, the query unit 606, and the result reflecting unit 607 may be partially implemented by dedicated hardware and the rest may be implemented by software.

The processor 201 and dedicated hardware are both processing circuits. That is, irrespective of being implemented by any of software, hardware, and a combination of software and hardware, the functions of the SNS providing unit 602, the submission determination unit 603, the event specifying unit 604, the query destination specifying unit 605, the query unit 606, and the result reflecting unit 607 are exerted by the processing circuits.

In the present embodiment, the function of the search processing unit 608 of the DS server 104 is implemented by software. As a modification example, the function of the search processing unit 608 may be implemented by hardware. That is, the DS server 104 may include dedicated hardware which implements the function of the search processing unit 608. This dedicated hardware is, for example, a single circuit, composite circuit, programmed processor, parallel-programmed processor, logic IC, GA, FPGA, or ASIC.

As another modification example, the function of the search processing unit 608 may be implemented by a combination of software and hardware. That is, the function of the search processing unit 608 may be partially implemented by dedicated hardware and the rest may be implemented by software.

The processor 201 and dedicated hardware are both processing circuits. That is, irrespective of being implemented by any of software, hardware, and a combination of software and hardware, the function of the search processing unit 608 is exerted by the processing circuits.

In the present embodiment, the functions of the observation unit 621, the query response unit 622, the data acquisition unit 623, and the event determination unit 624 of the machine management device 105 are implemented by software. As a modification example, the functions of the observation unit 621, the query response unit 622, the data acquisition unit 623, and the event determination unit 624 may be implemented by hardware. That is, the machine management device 105 may include dedicated hardware which implements the functions of the observation unit 621, the query response unit 622, the data acquisition unit 623, and the event determination unit 624. This dedicated hardware is, for example, a single circuit, composite circuit, programmed processor, parallel-programmed processor, logic IC, GA, FPGA, or ASIC.

As another modification example, the functions of the observation unit 621, the query response unit 622, the data acquisition unit 623, and the event determination unit 624 may be implemented by a combination of software and hardware. That is, the functions of the observation unit 621, the query response unit 622, the data acquisition unit 623, and the event determination unit 624 may be partially implemented by dedicated hardware and the rest may be implemented by software.

The processor 201 and dedicated hardware are both processing circuits. That is, irrespective of being implemented by any of software, hardware, and a combination of software and hardware, the functions of the observation unit 621, the query response unit 622, the data acquisition unit 623, and the event determination unit 624 are exerted by the processing circuits.

### Embodiment 2

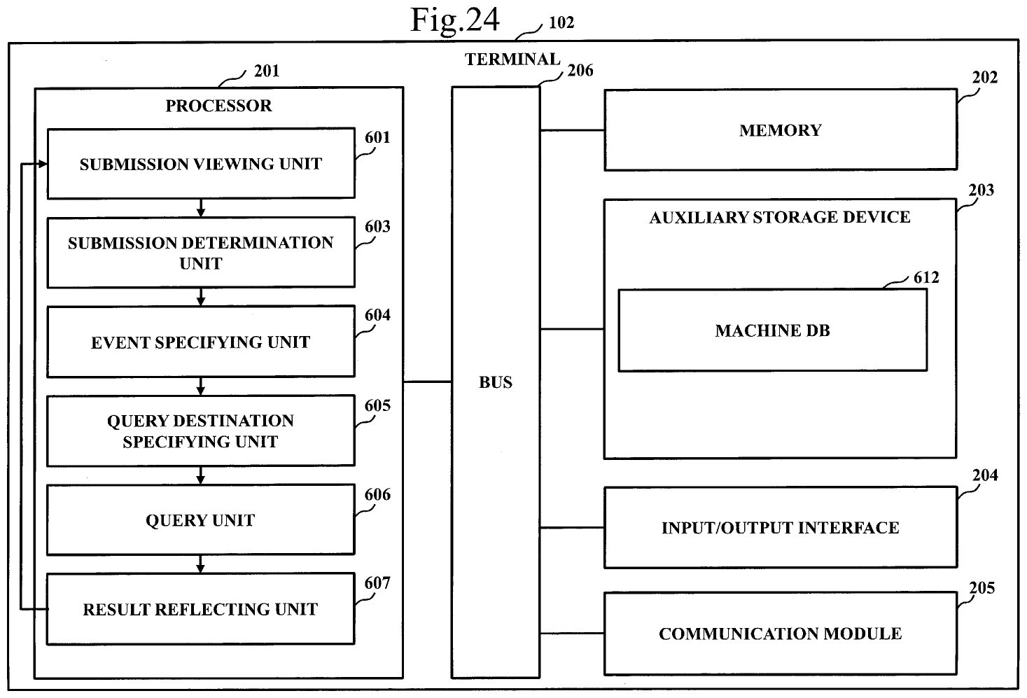

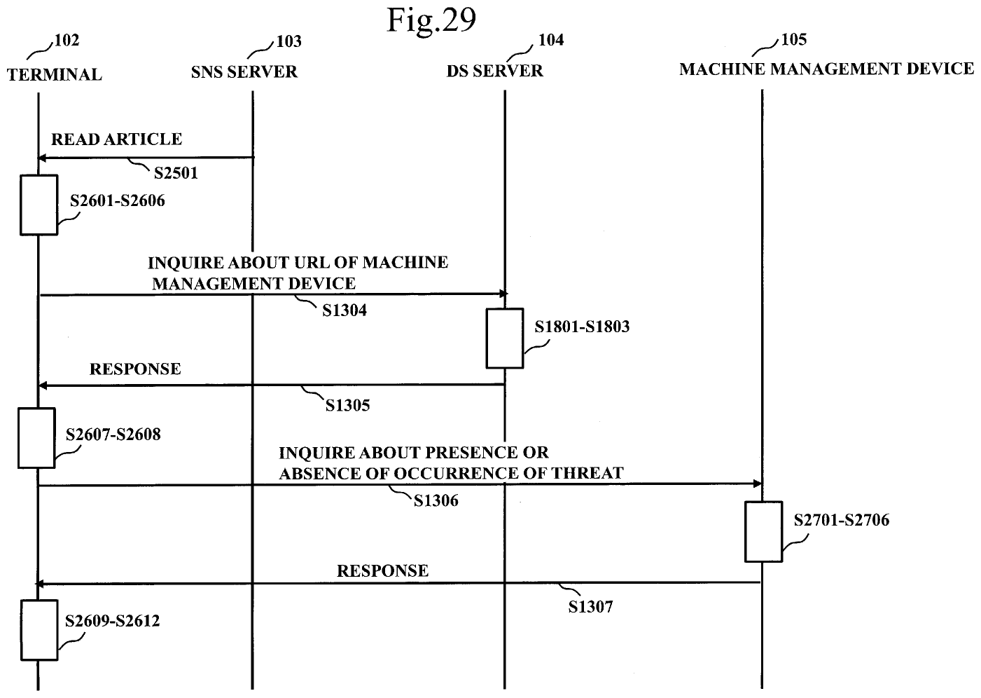

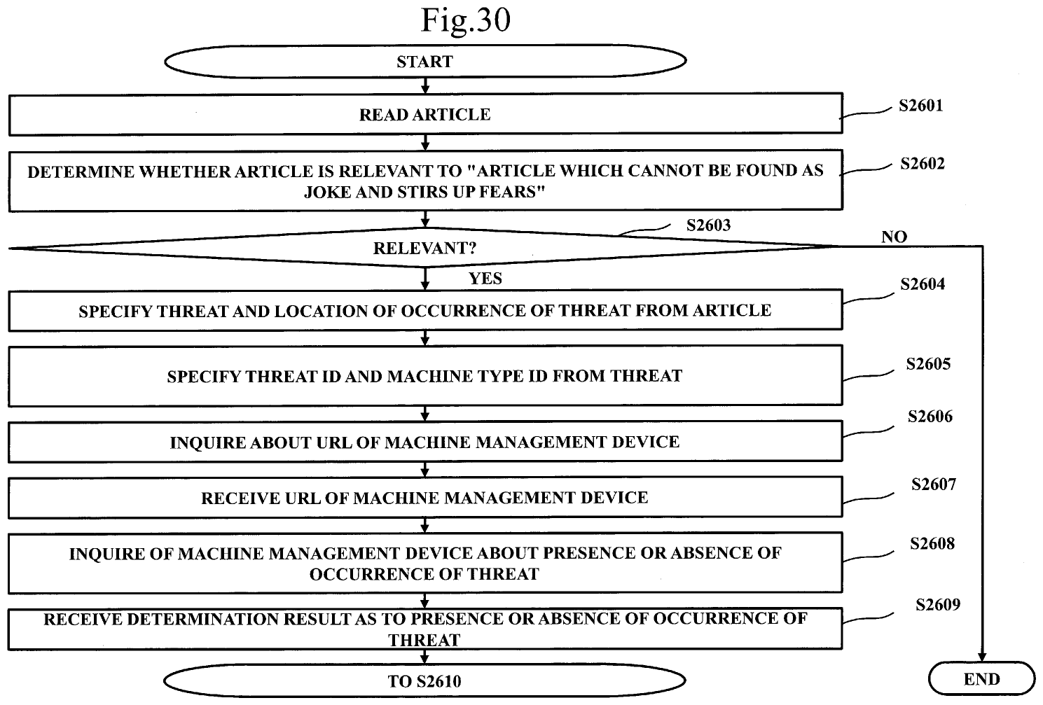

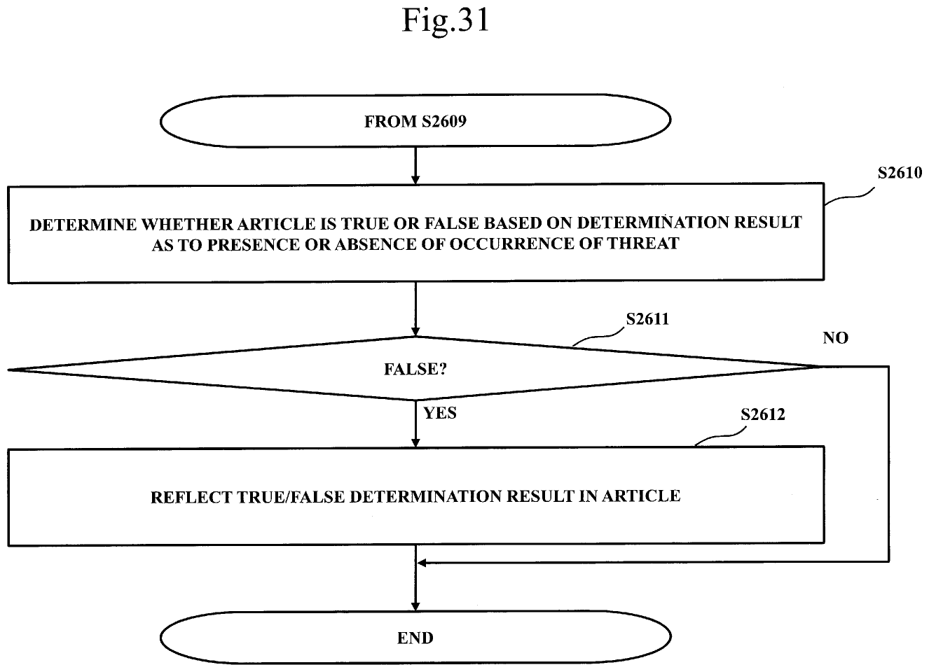

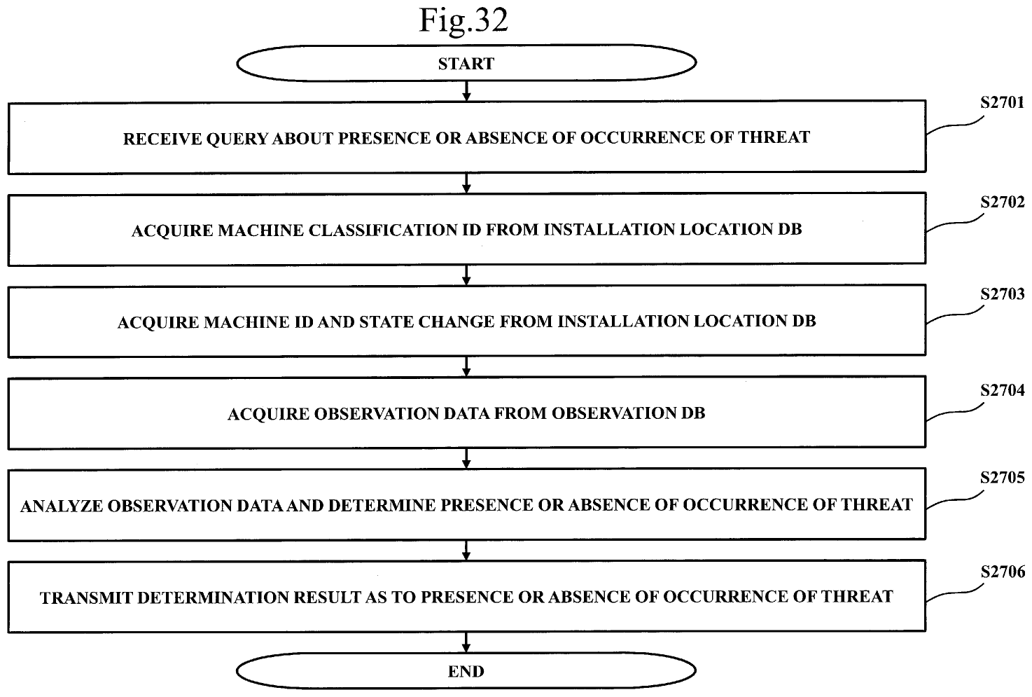

As for the present embodiment, differences from Embodiment 1 are mainly described by using FIG. 24 to FIG. 32.

### Description of Configuration

Since the configuration of the false submission filter system 100 according to the present embodiment is identical to that of Embodiment 1 illustrated in FIG. 1, description is omitted.

In Embodiment 1, the subject which inquires whether the submitted article is true or false is the SNS server 103. Also, the state change 751 of the machine indicating the occurrence of the threat 701 is defined for each machine classification ID 741 and is registered in the correspondence table 681 of the state change database 632. In the present embodiment, the subject which inquires whether the submitted article is true or false is the terminal 102. Also, the state change 751 of the machine indicating the occurrence of the threat 701 is defined for each machine ID 771 and is registered in the correspondence table 682 of the installation location database 633. Note that as a modification example of the present embodiment, as with Embodiment 1, the state change 751 of the machine indicating the occurrence of the threat 701 may be defined for each machine classification ID 741 and may be registered in the correspondence table 681 of the state change database 632.

In the present embodiment, the terminal 102 corresponds to a false submission filter device. The terminal 102 is operated by a user using a service which publishes a submission on a network. The service is SNS in the present embodiment, but may be a service other than SNS. The network as a publishing destination is the Internet 101 in the present embodiment, but may be a network of another type, such as an intranet of a company.

With reference to FIG. 24, the configuration of the terminal 102 according to the present embodiment is described.

The terminal 102 includes the submission viewing unit 601, as well as the submission determination unit 603, the event specifying unit 604, the query destination specifying unit 605, the query unit 606, the result reflecting unit 607, and the machine database 612, which are included in the SNS server 103 in Embodiment 1. The functions of the submission viewing unit 601, the submission determination unit 603, the event specifying unit 604, the query destination specifying unit 605, the query unit 606, and the result reflecting unit 607 are implemented by software. The machine database 612 may be constructed on the memory 202, but is constructed in the auxiliary storage device 203 in the present embodiment. The machine database 612 will be described further below.

In the present embodiment, a submission program and a false submission filter program are stored in advance in the auxiliary storage device 203. As with Embodiment 1, the submission program is a program which implements the function of the submission viewing unit 601. The false submission filter program is a program which implements the functions of the submission determination unit 603, the event specifying unit 604, the query destination specifying unit 605, the query unit 606, and the result reflecting unit 607. The submission program and the false submission filter program are loaded onto the memory 202, read to the processor 201, and executed by the processor 201.

Since the configuration of the submission determination unit 603 is identical to that of Embodiment 1 illustrated in FIG. 4, description is omitted.

Since the configuration of the event specifying unit 604 is identical to that of Embodiment 1 illustrated in FIG. 5, description is omitted.

Since the configuration of the location specifying unit 652 of the event specifying unit 604 is identical to that of Embodiment 1 illustrated in FIG. 6, description is omitted.

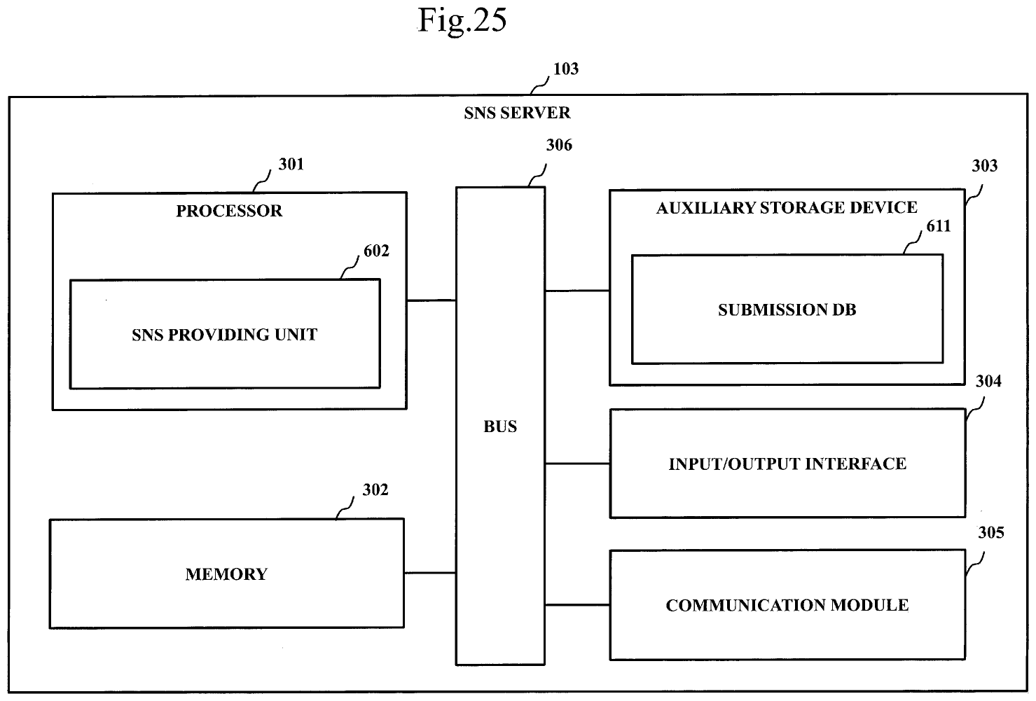

With reference to FIG. 25, the configuration of the SNS server 103 according to the present embodiment is described.

The SNS server 103 includes the SNS providing unit 602 and the submission database 611. The function of the SNS providing unit 602 is implemented by software. The submission database 611 may be constructed on the memory 302, but is constructed in the auxiliary storage device 303 in the present embodiment. As with Embodiment 1, the submission database 611 is a database which stores and manages submitted articles from the terminal 102.

In the present embodiment, an SNS program is stored in advance in the auxiliary storage device 303. As with Embodiment 1, the SNS program is a program which implements the function of the SNS providing unit 602. The SNS program is loaded onto the memory 302, read to the processor 301, and executed by the processor 301.

Since the configuration of the DS server 104 according to the present embodiment is identical to that of Embodiment 1 illustrated in FIG. 7, description is omitted.

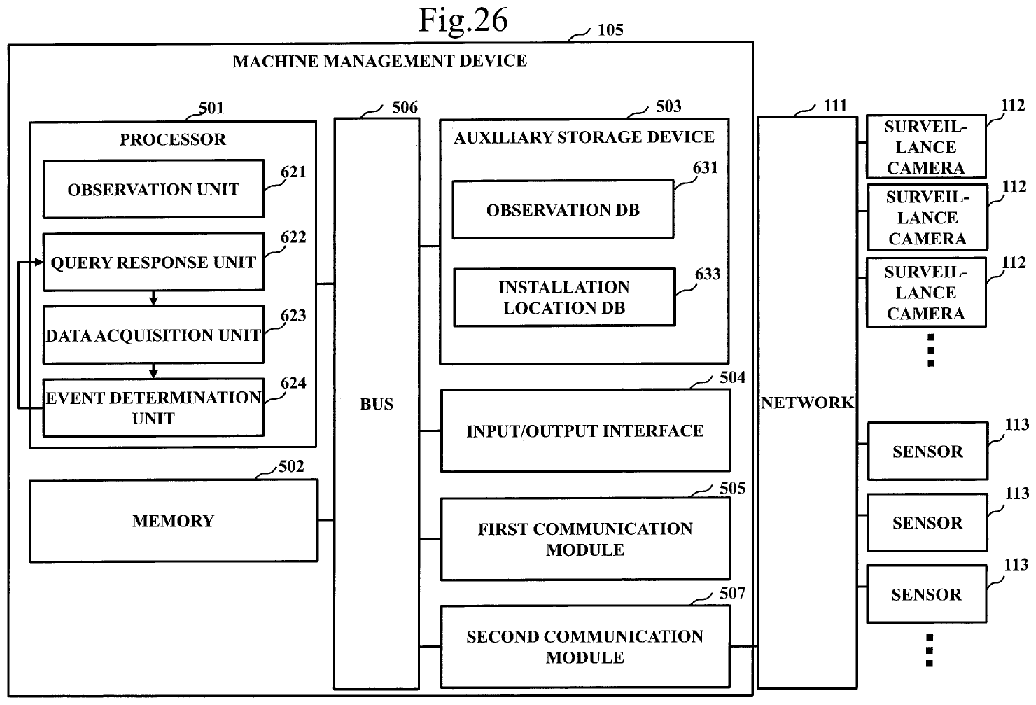

With reference to FIG. 26, the configuration of the machine management device 105 according to the present embodiment is described.

In Embodiment 1, the state change database 632 is included in the machine management device 105. In the present embodiment, however, the state change database 632 is unified into the installation location database 633. The installation location database 633 will be described further below.

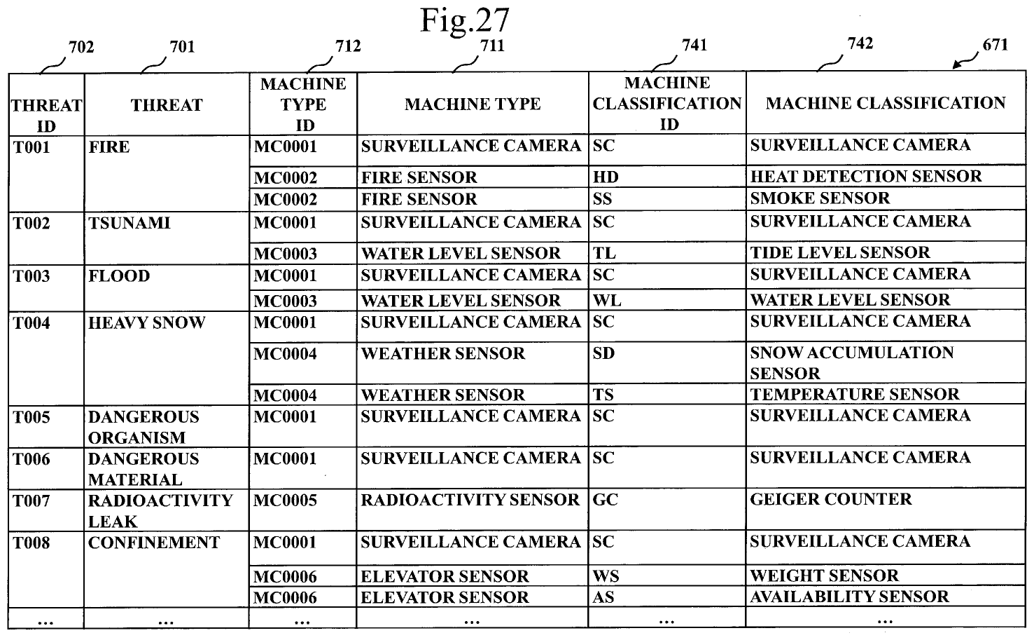

A correspondence table 671 registered in the machine database 612 of the terminal 102 is illustrated in FIG. 27.

The machine database 612 is a database which stores data specifying the machine type 711 corresponding to the threat 701. Specifically, the machine database 612 is a database in which a correspondence among the threat 701, the machine type 711 of a machine to be checked, and the machine classification 742 is registered as the correspondence table 671.

The correspondence table 671 of the machine database 612 is formed of at least six items, that is, the threat 701, the threat ID 702, the machine type 711, the machine type ID 712, the machine classification ID 741, and the machine classification 742. In the correspondence table 671 of the machine database 612, the machine type ID 712 and the machine classification ID 741 are registered for each threat ID 702. That is, it is indicated which machine classification 742 is to be checked for the threat 701 to allow the presence or absence of occurrence of the threat 701 to be checked. The machine classification ID 741 and the machine classification 742 may be omitted. The threat 701, the machine type 711, and the machine classification 742 are convenient for manually managing the correspondence table 671 of the machine database 612, but is not imperative.

Since the correspondence table 672 registered in the query destination database 613 of the DS server 104 is identical to that of Embodiment 1 illustrated in FIG. 10, description is omitted.

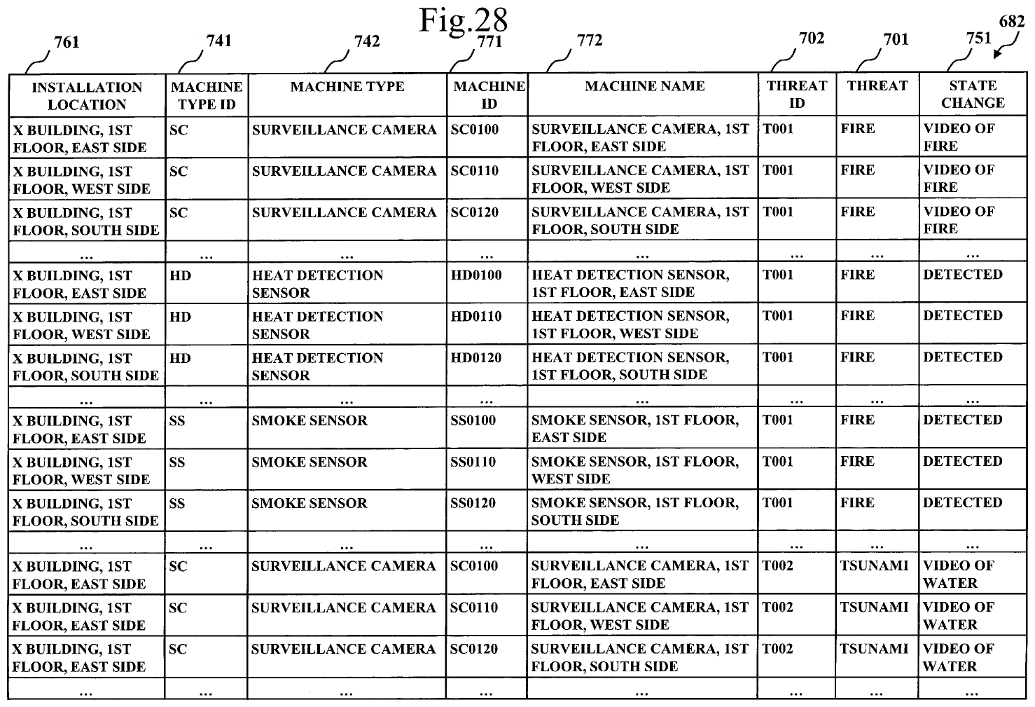

A correspondence table 682 registered in the installation location database 633 of the machine management device 105 is illustrated in FIG. 28.

The installation location database 633 is a database in which a correspondence among the installation location 761, the machine classification 742, the machine name 772, the threat 701, and the state change 751 is registered as the correspondence table 682.

The correspondence table 682 of the installation location database 633 is formed of at least eight items, that is, the installation location 761, the machine classification ID 741, the machine classification 742, the machine ID 771, the machine name 772, the threat ID 702, the threat 701, and the state change 751. In the correspondence table 682 of the installation location database 633, the machine ID 771, the threat ID 702, and the state change 751 of the machine at the time of occurrence of the threat 701 are registered for each of the installation location 761 and the machine classification ID 741. That is, in a machine relevant to a specific machine classification 742 at a specific installation location 761, it is indicated which state change 751 of each machine is to be checked for which threat 701 to allow the presence or absence of occurrence of the threat 701 to be checked. The state change 751 is a change of state to be checked. If the registered state change 751 is occurring in the machine, this means that the threat 701 is occurring. By varying the state change 751 for each machine ID 771, the state change 751 in accordance with the environment of the machine management device 105 and the specification of the machine can be set. In the correspondence table 682 of the installation location database 633, only the followings are registered: the installation location 761, the machine classification ID 741, the machine classification 742, the machine ID 771, and the machine name 772 of the machine managed by the machine management device 105; the threat 701 that can be checked by machine management device 105; and the state change 751 for the machine. The machine classification 742, the machine name 772, and the threat 701 are convenient for manually managing the correspondence table 682 of the installation location database 633, but are not imperative. By using the machine ID 771 registered in the correspondence table 682 of the installation location database 633, the machine management device 105 can acquire observation data of a specific machine stored in the observation database 631.

### Description of Operation

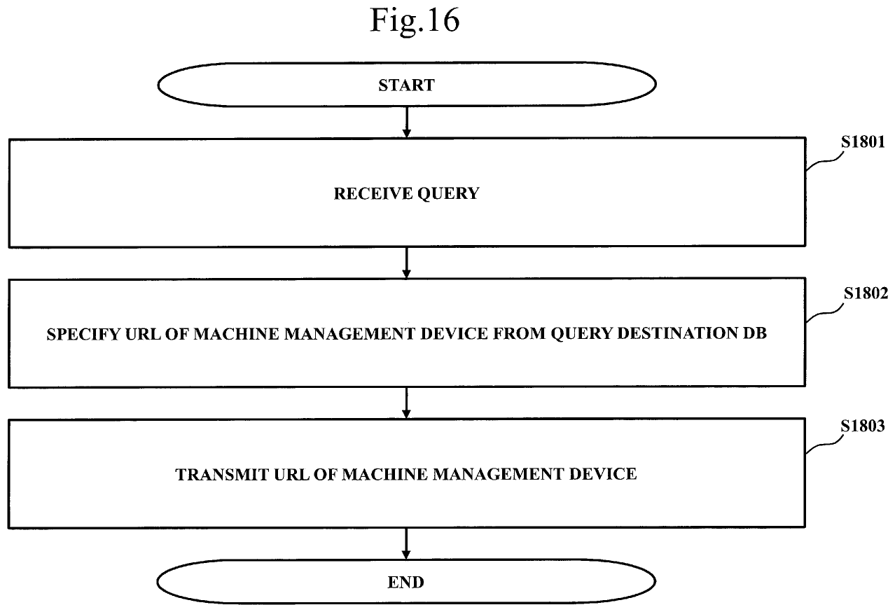

With reference to FIG. 1, FIG. 7, FIG. 10, and FIG. 24 to FIG. 28 as well as FIG. 16 and FIG. 29 to FIG. 32, the operation of the false submission filter system 100 according to the present embodiment is described. The operation of the false submission filter system 100 corresponds to a false submission filter method according to the present embodiment.

At step S2501 and step S2601, the submission viewing unit 601 of the terminal 102 accepts an operation of a reader as a user via the input/output interface 204, and reads, from the SNS server 103 via the communication module 205, an article submitted to the SNS server 103. As a specific example, it is assumed that a submitted article “A fire at X building in XXX town, danger!” to stir up fears of others is read from SNS. In this example, it is assumed that an image and GPS information of a submission location are affixed to the submitted article. It is assumed that GPS information of an image-taken location is included in the image.

At step S2602, the submission determination unit 603 of the terminal 102 determines whether the submitted article is an article to stir up fears of others and whether the submitted article is clearly a joke. Since details of the process at step S2602 are identical to the process at step S1403 illustrated in FIG. 19 to be performed by the submission determination unit 603 of the SNS server 103 in Embodiment 1, description is omitted. At step S2603, a branch process in accordance with the determination results at step S2602 is performed. When it is determined at step S2602 that the submitted article is not an article to stir up fears of others or that it is an article to stir up fears of others but is clearly a joke, the process flow ends. When it is determined at step S2602 that the submitted article is an article to stir up fears of others and is not clearly a joke, a process at step S2604 is performed.

At step S2604, the event specifying unit 604 of the terminal 102 specifies, from the submitted article, the threat 701 as a source of fear and the location 721 of occurrence of the threat 701. In the present example, the threat 701 is “fire”. The location 721 of occurrence of the threat 701 is “XXX prefecture, XXX city, XXX town, X-X, X building”. Since details of the process at step S2604 are identical to the process at step S1405 illustrated in FIG. 20 to be performed by the event specifying unit 604 of the SNS server 103 in Embodiment 1, description is omitted.

At step S2605, the query destination specifying unit 605 of the terminal 102 searches the correspondence table 671 of the machine database 612 based on the threat 701 specified by the event specifying unit 604, and specifies the threat ID 702 corresponding to the threat 701 and the machine type ID 712 of a machine to be checked. In the present example, for “fire” as the threat 701, the threat ID 702 is “T001” and the machine type IDs 712 of machines to be checked are “MC0001” corresponding to “surveillance camera” and “MC0002” corresponding to “fire sensor”.

At step S1304 and step S2606, the query destination specifying unit 605 transmits, via the communication module 205 to the DS server 104, the location 721 of occurrence of the threat 701 specified by the event specifying unit 604 and the machine type IDs 712 of the machines to be checked, and inquires about the URL 731 of the machine management device 105 as a query destination. In the present example, the query destination specifying unit 605 transmits “XXX prefecture, XXX city, XXX town, X-X, X building” as the location 721 of occurrence of the threat 701 and “MC0001” and “MC0002” as the machine type IDs 712 to the DS server 104.

At step S1801, the search processing unit 608 of the DS server 104 receives the query from the terminal 102 via the communication module 405. At step S1802, from the location 721 of occurrence of the threat 701 and the machine type IDs 712 indicated by the received query, the search processing unit 608 searches the correspondence table 672 of the query destination database 613, and specifies the URL 731 of the machine management device 105 as the query destination. In the present example, the URL 731 of the machine management device 105 which manages both of “surveillance camera” and “fire sensor” respectively corresponding to “MC0001” and “MC0002” as the machine type IDs 712 at “XXX prefecture, XXX city, XXX town, X-X, X building” as the location 721 of occurrence of the threat 701 is “http://xxx.xxx.co.jp/iot”. Note that if the machine management device 105 at “XXX prefecture, XXX city, XXX town, X-X, X building” is not present, the URL 731 of the machine management device 105 which manages a machine at “XXX prefecture, XXX city, XXX town, X-X” may be specified.

At step S1305 and step S1803, the search processing unit 608 transmits the URL 731 of the specified machine management device 105 via the communication module 405 to the terminal 102. In the present example, the search processing unit 608 transmits “http://xxx.xxx.co.jp/iot” as the URL 731 of the machine management device 105.

At step S2607, the query destination specifying unit 605 of the terminal 102 receives a response from the DS server 104 via the communication module 205. In the present example, the query destination specifying unit 605 receives a response indicating that the URL 731 of the machine management device 105 as a query destination is “http://xxx.xxx.co.jp/iot” for both.

At step S1306 and step S2608, the query unit 606 of the terminal 102 transmits the threat ID 702, the location 721 of occurrence of the threat 701, and a time when the article was submitted as a time of occurrence of the threat 701, via the communication module 205 to the URL 731 of the machine management device 105 as the query destination specified by the query destination specifying unit 605, and inquires about the presence or absence of occurrence of the threat 701. Note that upon request from the machine management device 105, the query unit 606 may also transmit, to the machine management device 105, the machine classification IDs 741 or the machine type IDs 712 of the machines to be checked as parameters of the URL 731 or the like. If there are a plurality of machine management devices 105 as query destinations, a query is directed to all of the machine management devices 105. In the present example, the query unit 606 transmits “T001” as the threat ID 702 and “XXX prefecture, XXX city, XXX town, X-X, X building” as the location 721 of occurrence of the threat 701 as well as the time of occurrence of the threat 701 to “http://xxx.xxx.co.jp/iot”, and inquires about the presence or absence of occurrence of “fire”. As required, the query unit 606 may transmit “SC”, “HD”, and “SS” as machine classification IDs 741 or “MC0001” and “MC0002” as machine type IDs 712.

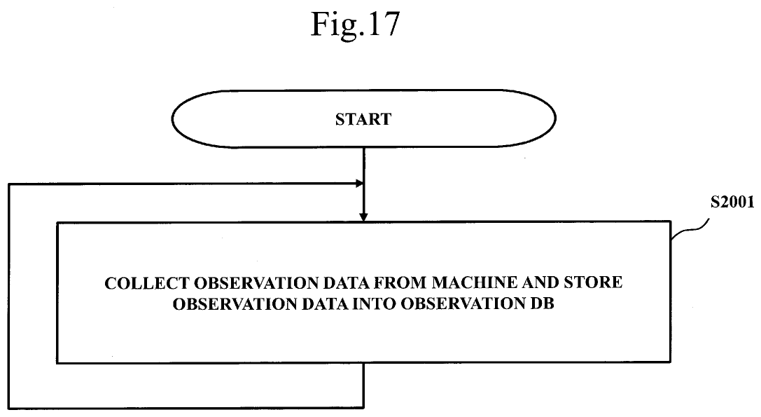

Since the process at step S2001 is identical to that of Embodiment 1 illustrated in FIG. 17, description is omitted.

At step S2701, the query response unit 622 of the machine management device 105 receives, via the first communication module 505, the query about the presence or absence of occurrence of the threat 701 from the terminal 102. The query about the presence or absence of occurrence of the threat 701 includes the threat ID 702, the location 721 of occurrence of the threat 701, and the time of occurrence of the threat 701. In the present example, as the query about the presence or absence of occurrence of the threat 701, the machine management device 105 at “XXX prefecture, XXX city, XXX town, X-X, X building” receives “T001” as the threat ID 702 and “XXX prefecture, XXX city, XXX town, X-X, X building” as the location 721 of occurrence of the threat 701 as well as the time of occurrence of the threat 701. Note that, as required, the machine management device 105 may receive “SC”, “HD”, and “SS” as machine classification IDs 741 or “MC0001” and “MC0002” as the machine type IDs 712.

At step S2702, the data acquisition unit 623 of the machine management device 105 extracts the threat ID 702, the location 721 of occurrence of the threat 701, and the time of occurrence of the threat 701 from the query about the presence or absence of occurrence of the threat 701 received by the query response unit 622. If the machine classification IDs 741 or the machine type IDs 712 are also transmitted as parameters of the URL 731 or the like, the data acquisition unit 623 also extracts the machine classification IDs 741 or the machine type IDs 712. Based on the threat ID 702 extracted from the query about the presence or absence of occurrence of the threat 701, the data acquisition unit 623 acquires, from the correspondence table 682 of the installation location database 633, the machine classification IDs 741 of the machines to be checked. Note that the data acquisition unit 623 may also use the machine type IDs 712 as required together with the threat ID 702 to acquire the machine classification IDs 741 of the machines to be checked. In the present example, the machine classification IDs 741 of the machines to be checked for the threat ID 702 “T001” corresponding to “fire” are “SC” corresponding to “surveillance camera”, “HD” corresponding to “heat detection sensor”, and “SS” corresponding to “smoke detection sensor”.

At step S2703, based on the threat ID 702 and the location 721 of occurrence extracted from the query about the presence or absence of occurrence of the threat 701 and the machine classification IDs 741 acquired from the installation location database 633, the data acquisition unit 623 acquires the machine IDs 771 of the machines to be checked and the state changes 751 of the machines at the time of occurrence of the threat 701 from the correspondence table 682 of the installation location database 633. In the present example, since the floor where the threat 701 is occurring is not indicated, the machine IDs 771 relevant to “SC”, “HD”, and “SS” of “XXX prefecture, XXX city, XXX town, X-X, X building” are “SC0100”, “SC0110”, “SC0120”, . . . ; “HD0100”, “HD0110”, “HD0120”, . . . ; and “SS0100”, “SS0110”, “SS0120”, . . . . At each of “surveillance cameras” with “SC0100”, “SC0110”, “SC0120”, . . . , when “video of fire” shows up, this means that “fire” is occurring. At each of “heat detection sensors” with “HD0100”, “HD0110”, “HD0120”, . . . , when heat is “detected”, this means that “fire” is occurring. At each of “smoke detection sensors” with “SS0100”, “SS0110”, “SS0120”, . . . , when smoke is “detected”, this means that “fire” is occurring.

At step S2704, based on the acquired machine IDs 771 and the time of occurrence extracted from the query about the presence or absence of occurrence of the threat 701, the data acquisition unit 623 acquires, from the observation database 631, observation data around the time of occurrence of the threat 701. In the present example, the data acquisition unit 623 acquires, from the observation database 631, observation data of the surveillance camera 112 and the sensor 113 corresponding to “SC0100”, “SC0110”, “SC0120”, . . . ; “HD0100”, “HD0110”, “HD0120”, . . . ; and “SS0100”, “SS0110”, “SS0120”, . . . around the time of occurrence of the threat 701. “Around the time of occurrence” is, for example, from one hour before the time of occurrence to the time of occurrence.

At step S2705, the event determination unit 624 of the machine management device 105 analyzes the observation data acquired by the data acquisition unit 623 from the observation database 631 to determine whether the state change 751 of each machine at the time of occurrence of the threat 701 is occurring. In the observation data, when the state change 751 of the machine occurs, this means that the threat 701 is occurring. When the state change 751 is not occurring, this means that the threat is not occurring. When the observation data is image data acquired from the surveillance camera 112, the event determination unit 624 uses AI technology such as image recognition technology or machine learning, to determine whether the state change 751 is occurring. When the presence or absence of occurrence of the threat 701 is determined from the observation data of a plurality of machines corresponding to different machine classification IDs 741, which determination criterion is to be used may be freely set by the administrator of the machine management device 105. In the present example, if “video of fire” shows up in any of image data “SC0100”, “SC0110”, “SC0120”, . . . ; heat is “detected” in any of data “HD0100”, “HD0110”, “HD0120”, . . . ; and smoke is “detected” in any of data “SS0100”, “SS0110”, “SS0120”, . . . , it is determined that “fire” is occurring.

At step S1307 and step S2706, the query response unit 622 transmits, via the first communication module 505, the determination result as to the presence or absence of occurrence of the threat 701 by the event determination unit 624 to the terminal 102 as a response to the query about the presence or absence of occurrence of the threat 701.

At step S2609, the query unit 606 of the terminal 102 receives, via the communication module 205 from all machine management devices 105 as query destinations, the determination result as to the presence or absence of occurrence of the threat 701.

At step S2610, based on the determination result as to the presence or absence of occurrence of the threat 701 received by the query unit 606, the result reflecting unit 607 of the terminal 102 determines whether the submitted article is true or false. The criteria for true/false determination when a query is transmitted to a plurality of machine management devices 105 may be freely set by the administrator of the terminal 102. At step S2611, a branch process in accordance with the determination result at step S2610 is performed. When it is determined at step S2610 that the submitted article is true, the process flow ends. When it is determined at step S2610 that the submitted article is false, a process at step S2612 is performed.

At step S2612, via the communication module 205, the result reflecting unit 607 provides a mark indicating that it is false to the submitted article or deletes the submitted article, and the submission viewing unit 601 of the terminal 102 allows the submitter 121 to view the article. Alternatively, at step S2612, via the communication module 205, the result reflecting unit 607 provides a mark indicating that it is false to the submitted article or deletes the submitted article, and requests the SNS server 103 to reflect the true/false determination result in the submitted article. Upon request, the SNS providing unit 602 of the SNS server 103 distributes the submitted article with the true/false determination result reflected therein via the communication module 205 to the terminal 102. The submission viewing unit 601 of the terminal 102 receives the article distributed from the SNS server 103 via the communication module 205 to allow the submitter 121 to view the article.

### Description of Effects of Embodiment

In the present embodiment, as with Embodiment 1, it is possible to perform both of quickly taking measures against false submission by determining whether the contents of the submission are true or false from the observation result of the machine and handling the observation result of the machine as secret information.

In the present embodiment, as with Embodiment 1, the false submitted article can be automatically and instantaneously deleted, or it can be displayed that the submitted article is a false article. As a result, it is possible to automatically prevent the false submitted article from being spread by readers motivated by fears and a social panic from being caused. Furthermore, the observation data of the surveillance camera 112 and the sensor 113 is handled as secret information of the management subject, and is not leaked outside the management subject.

### Other Configurations

As a modification example of the present embodiment, the DS server 104 may be unified into the terminal 102.

In the present embodiment, the functions of the submission viewing unit 601, the submission determination unit 603, the event specifying unit 604, the query destination specifying unit 605, the query unit 606, and the result reflecting unit 607 of the terminal 102 are implemented by software. The functions of the submission viewing unit 601, the submission determination unit 603, the event specifying unit 604, the query destination specifying unit 605, the query unit 606, and the result reflecting unit 607 may be implemented by hardware. Alternatively, the functions of the submission viewing unit 601, the submission determination unit 603, the event specifying unit 604, the query destination specifying unit 605, the query unit 606, and the result reflecting unit 607 may be implemented by a combination of software and hardware.

In the present embodiment, the function of the SNS providing unit 602 of the SNS server 103 is implemented by software. The function of the SNS providing unit 602 may be implemented by hardware. Alternatively, the function of the SNS providing unit 602 may be implemented by a combination of software and hardware.

### Embodiment 3

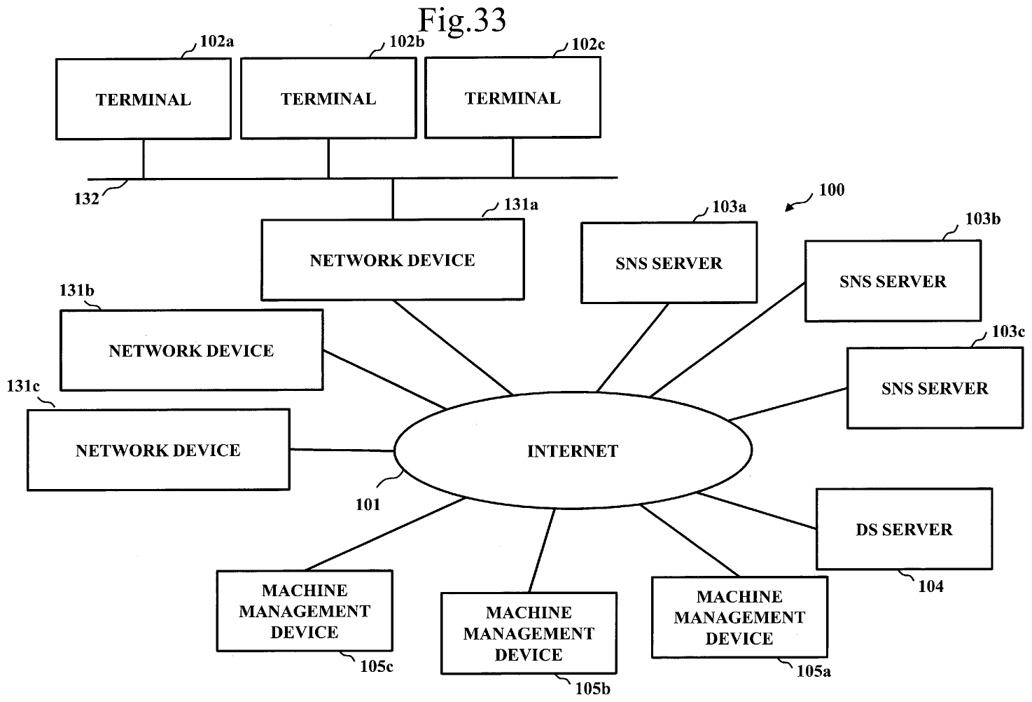

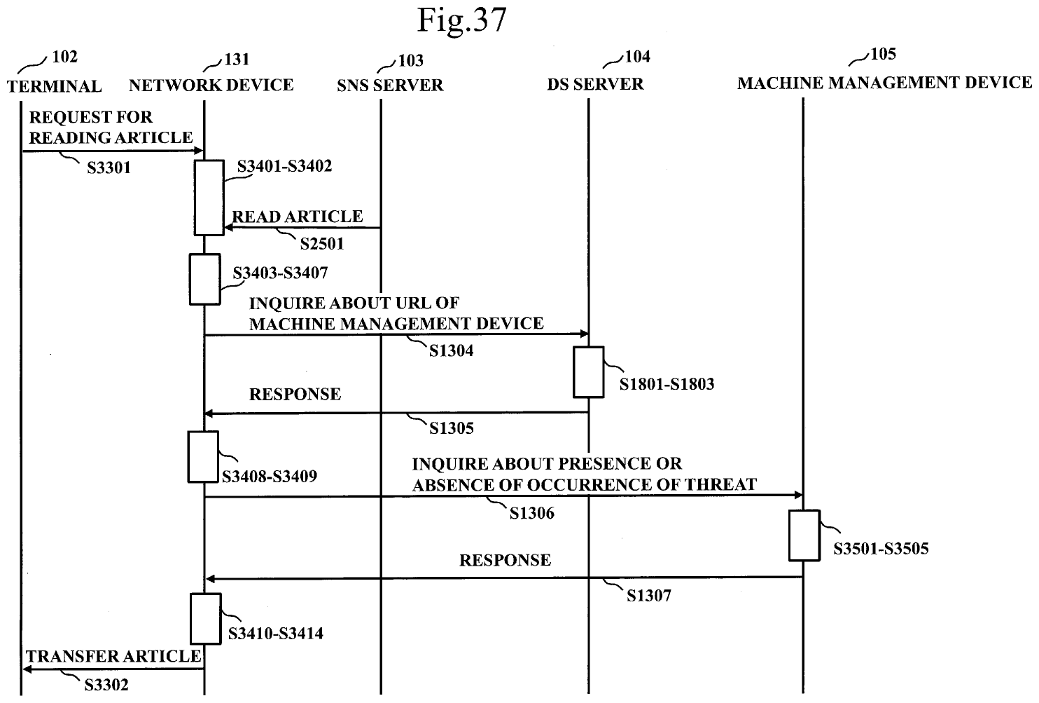

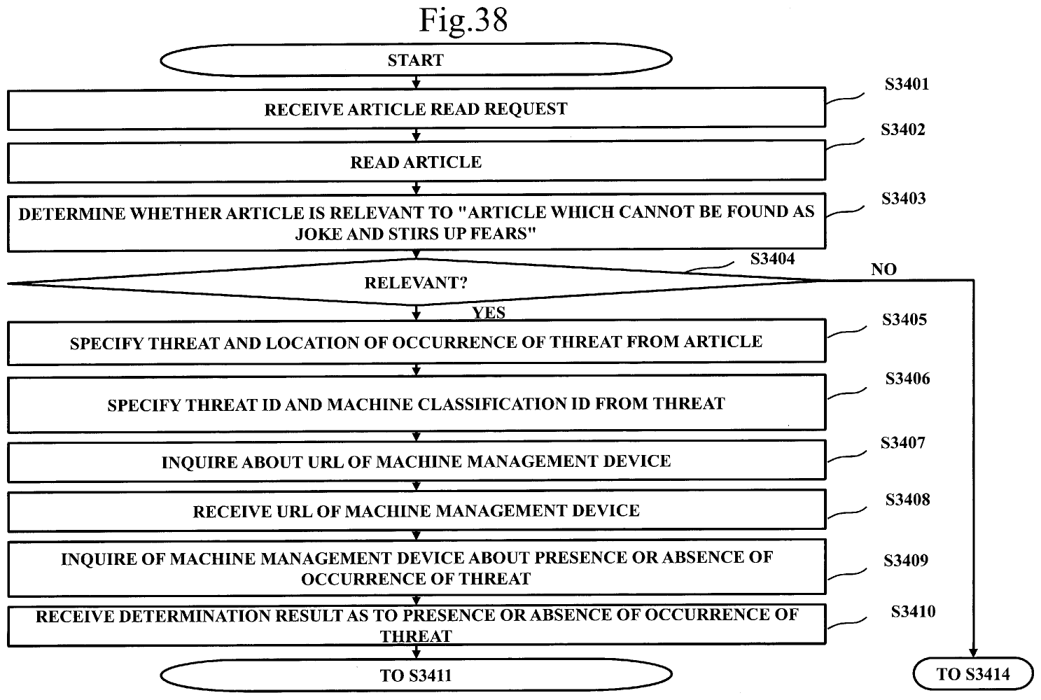

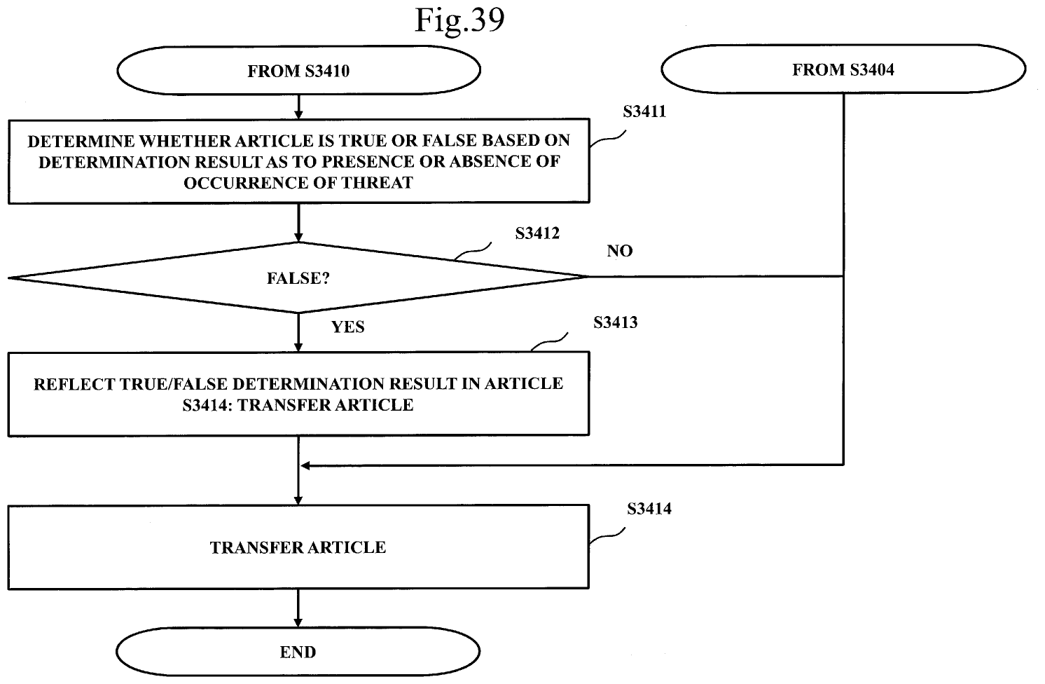

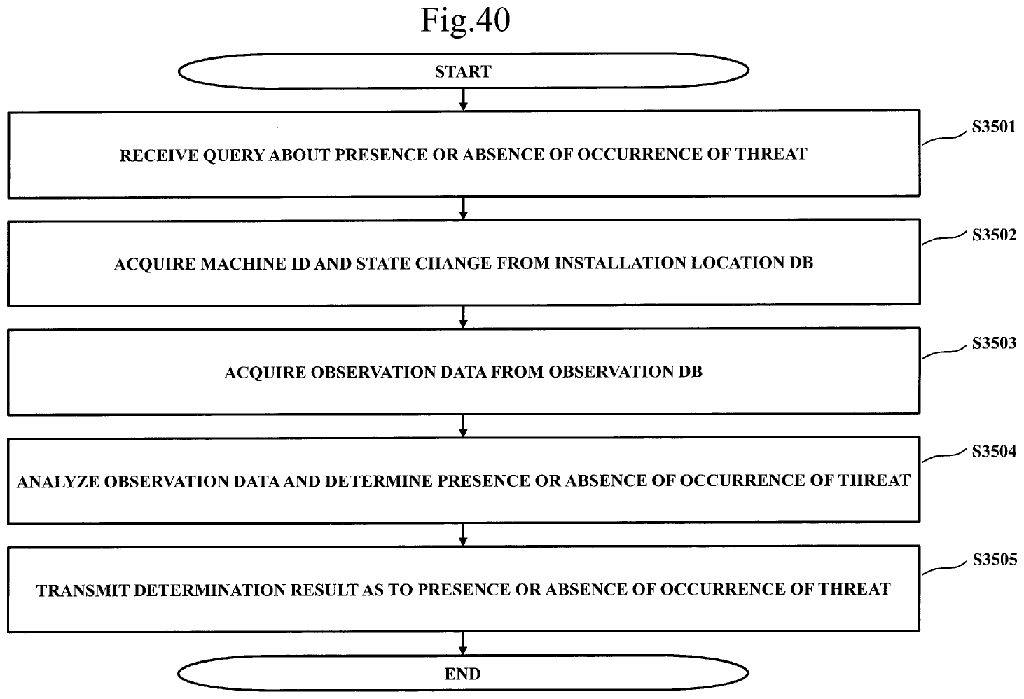

As for the present embodiment, differences from Embodiment 2 are mainly described by using FIG. 33 to FIG. 40.

### Description of Configuration

With reference to FIG. 33, the configuration of the false submission filter system 100 according to the present embodiment is described.

The false submission filter system 100 further includes a plurality of network devices 131a, 131b, 131c, . . . .

In the following, the plurality of network devices 131a, 131b, 131c, . . . are collectively referred to as a network device 131.

The terminal 102 is connected via a LAN 132 to the network device 131 such as a UTM, proxy, or the like. “UTM” is an abbreviation for Unified Threat Management. The network device 131 is connected to the SNS server 103 via the Internet 101.

In Embodiment 2, the subject which inquires whether the submitted article is true or false is the terminal 102. Also, to make a query to the machine management device 105 and a response from the machine management device 105 efficient, the machine type 711 indicating an abstracted machine is introduced. In the present embodiment, the subject which inquires whether the submitted article is true or false is the network device 131. Also, the machine type 711 is not introduced. Note that, as with Embodiment 2, the machine type 711 may be introduced as a modification example of the present embodiment.

In the present embodiment, the network device 131 corresponds to a false submission filter device. The network device 131 is a device installed between the terminal 102 of the user and the SNS server 103 which accepts a submission from the terminal of the user and publishes the submission on a network. The submission is a submission to SNS in the present embodiment, but may be a submission to a service other than SNS, or a site. The network as a publishing destination is the Internet 101 in the present embodiment, but may be a network of another type, such as an intranet of a company.

The configuration of the terminal 102 according to the present embodiment is different from that of Embodiment 2 illustrated in FIG. 24, but is identical to that of Embodiment 1 illustrated in FIG. 2, and description is therefore omitted.

The configuration of the SNS server 103 according to the present embodiment is identical to that of Embodiment 2 illustrated in FIG. 25, and description is therefore omitted.

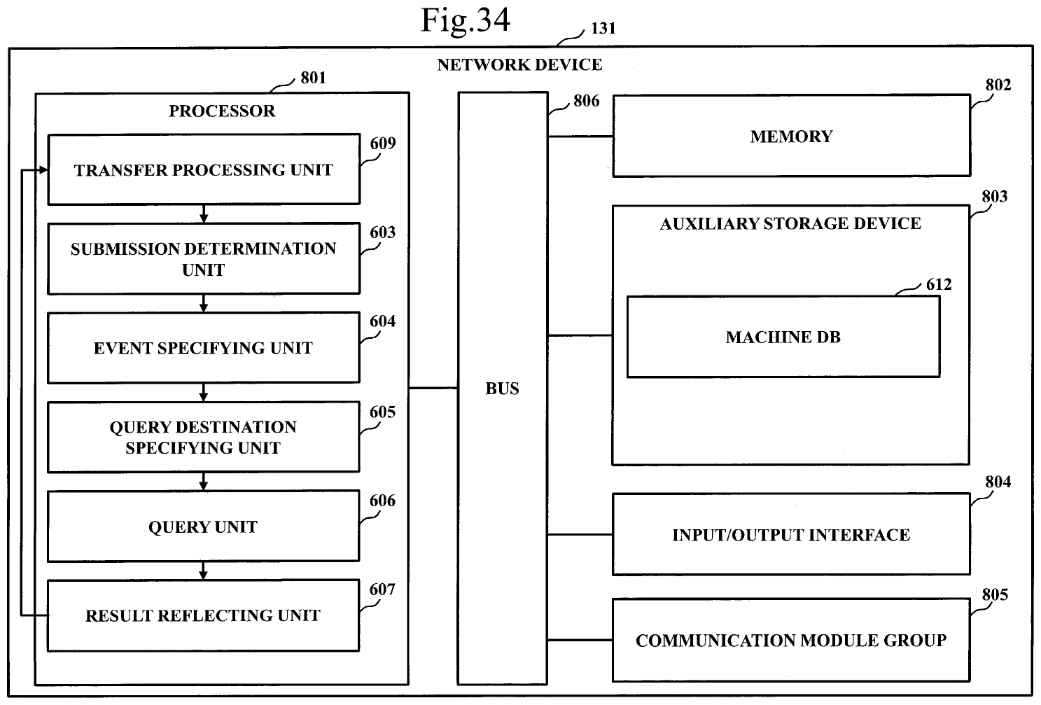

With reference to FIG. 34, the configuration of the network device 131 according to the present embodiment is described.

The network device 131 is a computer. The network device 131 includes a processor 801 and other pieces of hardware such as a memory 802, an auxiliary storage device 803, an input/output interface 804, and a communication module group 805. The processor 801 is connected via a bus 806 to the other pieces of hardware to control these other pieces of hardware.

The network device 131 includes a transfer processing unit 609, as well as the submission determination unit 603, the event specifying unit 604, the query destination specifying unit 605, the query unit 606, the result reflecting unit 607, and the machine database 612, which are included in the terminal 102 in Embodiment 2. The functions of the transfer processing unit 609, the submission determination unit 603, the event specifying unit 604, the query destination specifying unit 605, the query unit 606, and the result reflecting unit 607 are implemented by software. The machine database 612 may be constructed on the memory 802, but is constructed in the auxiliary storage device 803 in the present embodiment. The machine database 612 will be described further below.

The processor 801 is a device which executes a transfer program and a false submission filter program. The transfer program is a program which implements the function of the transfer processing unit 609. The false submission filter program is a program which implements the functions of the submission determination unit 603, the event specifying unit 604, the query destination specifying unit 605, the query unit 606, and the result reflecting unit 607. The processor 801 is, for example, a CPU.

The memory 802 and the auxiliary storage device 803 are devices which store the transfer program and the false submission filter program. The memory 802 is, for example, a flash memory or RAM. The auxiliary storage device 803 is, for example, a flash memory or HDD.

The transfer program and the false submission filter program are stored in advance in the auxiliary storage device 803. The transfer program and the false submission filter program are loaded onto the memory 802, read to the processor 801, and executed by the processor 801. In the auxiliary storage device 803, not only the transfer program and the false submission filter program but also an OS is stored. The processor 801 executes the transfer program and the false submission filter program while executing the OS.

Note that a part or entire of the transfer program and the false submission filter program may be incorporated in the OS.

The input/output interface 804 includes an input interface to which an input device not illustrated is connected and an output interface to which a display not illustrated is connected. The input device is a device to be operated by the user to input data to the transfer program and the false submission filter program. The input device is, for example, a mouse, keyboard, or touch panel. The display is a device which displays data outputted from the transfer program and the false submission filter program on a screen. The display is, for example, an LCD.

Each module of the communication module group 805 includes a receiver which receives data inputted to the transfer program and the false submission filter program and a transmitter which transmits data outputted from the transfer program and the false submission filter program. Each module of the communication module group 805 is, for example, a communication chip or NIC. The communication module group 805 is connected to the LAN 132 and the Internet 101.

The network device 131 may include a plurality of processors which replace the processor 801. The plurality of these processors share execution of the transfer program and the false submission filter program. Each processor is, for example, a CPU.

Data, information, signal values, and variable values to be used, processed, or outputted by the transfer program and the false submission filter program are stored in the memory 802, the auxiliary storage device 803, or a register or cache memory in the processor 801.

The transfer program is a program which causes the computer to execute a “process” wherein the “unit” of the transfer processing unit 609 is read as “process” . . . . Alternatively, the transfer program is a program which causes the computer to execute a “procedure” wherein the “unit” of the transfer processing unit 609 is read as “procedure”. The transfer program may be provided as being recorded on a computer-readable medium or provided as a program product.

Since the configuration of the submission determination unit 603 is identical to that of Embodiment 1 and Embodiment 2 illustrated in FIG. 4, description is omitted.

Since the configuration of the event specifying unit 604 is identical to that of Embodiment 1 and Embodiment 2 illustrated in FIG. 5, description is omitted.

Since the configuration of the location specifying unit 652 of the event specifying unit 604 is identical to that of Embodiment 1 and Embodiment 2 illustrated in FIG. 6, description is omitted.

Since the configuration of the DS server 104 according to the present embodiment is identical to that of Embodiment 1 and Embodiment 2 illustrated in FIG. 7, description is omitted.

Since the configuration of the machine management device 105 according to the present embodiment is identical to that of Embodiment 2 illustrated in FIG. 26, description is omitted.

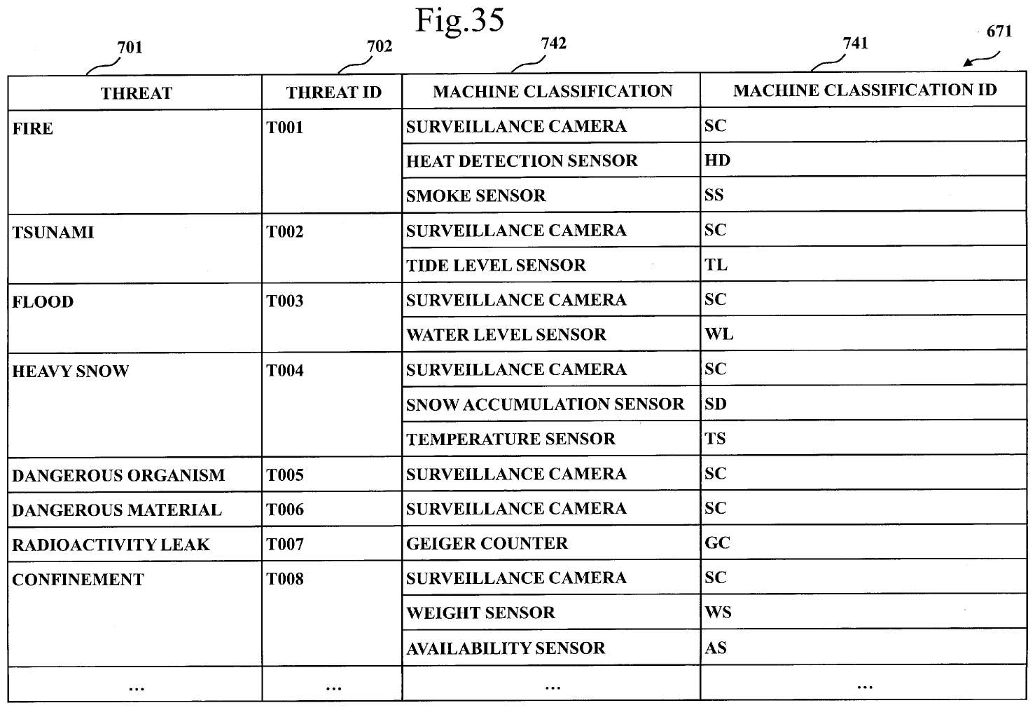

A correspondence table 671 registered in the machine database 612 of the network device 131 is illustrated in FIG. 35.

The machine database 612 is a database which stores data specifying the machine classification 742 corresponding to the threat 701. Specifically, the machine database 612 is a database in which a correspondence between the threat 701 and the machine classification 742 of a machine to be checked is registered as the correspondence table 671.

The correspondence table 671 of the machine database 612 is formed of at least four items, that is, the threat 701, the threat ID 702, the machine classification ID 741, and the machine classification 742. In the correspondence table 671 of the machine database 612, the machine classification ID 741 is registered for each threat ID 702. That is, it is indicated which machine classification 742 is to be checked for the threat 701 to allow the presence or absence of occurrence of the threat 701 to be checked. The threat 701 and the machine classification 742 are convenient for manually managing the correspondence table 671 of the machine database 612, but are not imperative.

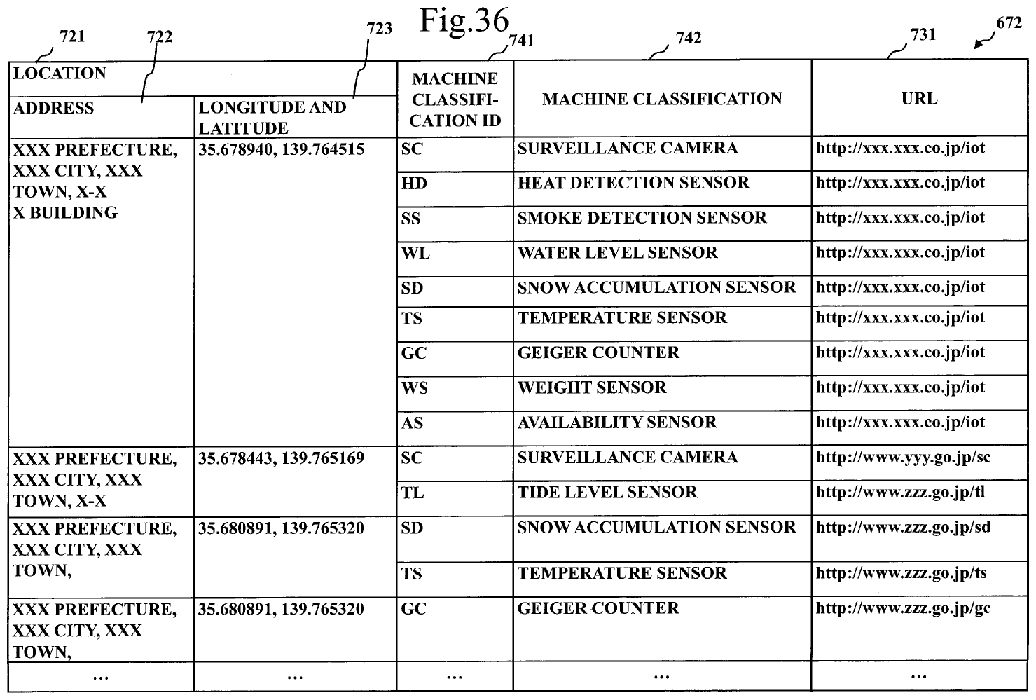

A correspondence table 672 registered in the query destination database 613 of the DS server 104 is illustrated in FIG. 36.

In Embodiment 1 and Embodiment 2, a correspondence among the location 721, the machine type 711 of the machine managed by the machine management device 105, and the URL 731 as a query destination is registered in the query destination database 613. In the present embodiment, a correspondence among the location 721, the machine classification 742 of the machine managed by the machine management device 105, and the URL 731 as a query destination is registered in the query destination database 613, as the correspondence table 672.

The correspondence table 672 of the query destination database 613 is formed of at least five items, that is, the address 722 and the longitude and latitude 723 of the location 721 where the machine is installed, the machine classification ID 741, the machine classification 742, and the URL 731. In the correspondence table 672 of the query destination database 613, the URL 731 is registered for each of the location 721 and the machine classification ID 741. That is, the URL 731 is indicated as a destination for a query about the presence or absence of occurrence of the threat 701 for the specific machine classification 742 at the specific location 721. The machine classification 742 is convenient for manually managing the correspondence table 672 of the query destination database 613, but is not imperative. In the correspondence table 672 of the query destination database 613, a different URL 731 or the same URL 731 may be registered for each machine classification 742 of the machine managed by the machine management device 105.

Since the correspondence table 682 registered in the installation location database 633 of the machine management device 105 is identical to that of Embodiment 2 illustrated in FIG. 28, description is omitted. However, the machine classification ID 741 and the machine classification 742 are not imperative.

### Description of Operation

With reference to FIG. 2, FIG. 7, FIG. 25, FIG. 26, FIG. 28, and FIG. 33 to FIG. 36 as well as FIG. 16 and FIG. 37 to FIG. 40, the operation of the false submission filter system 100 according to the present embodiment is described. The operation of the false submission filter system 100 corresponds to a false submission filter method according to the present embodiment.

At step S3301, the submission viewing unit 601 of the terminal 102 accepts an operation of the reader as a user via the input/output interface 204, and requests, via the communication module 205, the network device 131 to read the article submitted to the SNS server 103. At step S3401, the transfer processing unit 609 of the network device 131 receives, via the communication module group 805, the request for reading the submitted article from the terminal 102. At step S2501 and step S3402, in response to the read request, the transfer processing unit 609 reads the submitted article via the communication module group 805 from the SNS server 103. As a specific example, it is assumed that a submitted article “A fire at X building in XXX town, danger!” to stir up fears of others is read from SNS. In this example, it is assumed that an image and GPS information of a submission location are affixed to the submitted article. It is assumed that GPS information of an image-taken location is included in the image.

At step S3403, the submission determination unit 603 of the network device 131 determines whether the submitted article is an article to stir up fears of others and whether the submitted article is clearly a joke. Since details of the process at step S3403 are identical to the process at step S1403 illustrated in FIG. 19 to be performed by the submission determination unit 603 of the SNS server 103 in Embodiment 1, description is omitted. At step S3404, a branch process in accordance with the determination results at step S3403 is performed. When it is determined at step S3403 that the submitted article is not an article to stir up fears of others or that it is an article to stir up fears of others but is clearly a joke, a process at step S3414 is performed. When it is determined at step S3403 that the submitted article is an article to stir up fears of others and is not clearly a joke, a process at step S3405 is performed.

At step S3405, the event specifying unit 604 of the network device 131 specifies, from the submitted article, the threat 701 as a source of fear and the location 721 of occurrence of the threat 701. In the present example, the threat 701 is “fire”. The location 721 of occurrence of the threat 701 is “XXX prefecture, XXX city, XXX town, X-X, X building”. Since details of the process at step S3405 are identical to the process at step S1405 illustrated in FIG. 20 to be performed by the event specifying unit 604 of the SNS server 103 in Embodiment 1, description is omitted.

At step S3406, the query destination specifying unit 605 of the network device 131 searches the correspondence table 671 of the machine database 612 based on the threat 701 specified by the event specifying unit 604, and specifies the threat ID 702 corresponding to the threat 701 and the machine classification ID 741 of a machine to be checked. In the present example, for “fire” as the threat 701, the threat ID 702 is “T001”, the machine classification IDs 741 of machines to be checked are “SC” corresponding to “surveillance camera”, “HD” corresponding to “heat detection sensor”, and “SS” corresponding to “smoke detection sensor”.

At step S1304 and step S3407, the query destination specifying unit 605 transmits, via the communication module group 805 to the DS server 104, the location 721 of occurrence of the threat 701 specified by the event specifying unit 604 and the machine classification IDs 741 of the machines to be checked, and inquires about the URL 731 of the machine management device 105 as a query destination. In the present example, the query destination specifying unit 605 transmits “XXX prefecture, XXX city, XXX town, X-X, X building” as the location 721 of occurrence of the threat 701 and “SC”, “HD”, and “SS” as the machine classification IDs 741 to the DS server 104.

At step S1801, the search processing unit 608 of the DS server 104 receives the query from the network device 131 via the communication module 405. At step S1802, from the location 721 of occurrence of the threat 701 and the machine classification IDs 741 indicated by the received query, the search processing unit 608 searches the correspondence table 672 of the query destination database 613, and specifies the URL 731 of the machine management device 105 as the query destination. In the present example, the URL 731 of the machine management device 105 which manages “surveillance camera”, “heat detection sensor”, and “smoke detection sensor” respectively corresponding to “SC”, “HD”, and “SS” as the machine classification IDs 741 at “XXX prefecture, XXX city, XXX town, X-X, X building” as the location 721 of occurrence of the threat 701 is “http://xxx.xxx.co.jp/iot”. Note that if the machine management device 105 at “XXX prefecture, XXX city, XXX town, X-X, X building” is not present, the URL 731 of the machine management device 105 which manages a machine at “XXX prefecture, XXX city, XXX town, X-X” may be specified.

At step S1305 and step S1803, the search processing unit 608 transmits the URL 731 of the specified machine management device 105 via the communication module 405 to the network device 131. In the present example, the search processing unit 608 transmits “http://xxx.xxx.co.jp/iot” as the URL 731 of the machine management device 105.

At step S3408, the query destination specifying unit 605 of the network device 131 receives a response from the DS server 104 via the communication module group 805. In the present example, the query destination specifying unit 605 receives a response indicating that the URL 731 of the machine management device 105 as a query destination is “http://xxx.xxx.co.jp/iot” for all.

At step S1306 and step S3409, the query unit 606 of the network device 131 transmits the threat ID 702, the location 721 of occurrence of the threat 701, and a time when the article was submitted as a time of occurrence of the threat 701, via the communication module group 805 to the URL 731 of the machine management device 105 as the query destination specified by the query destination specifying unit 605, and inquires about the presence or absence of occurrence of the threat 701. Note that upon request from the machine management device 105, the query unit 606 may also transmit, to the machine management device 105, the machine classification IDs 741 of the machines to be checked as parameters of the URL 731 or the like. If there are a plurality of machine management devices 105 as query destinations, a query is directed to all of the machine management devices 105. In the present example, the query unit 606 transmits “T001” as the threat ID 702 and “XXX prefecture, XXX city, XXX town, X-X, X building” as the location 721 of occurrence of the threat 701 as well as the time of occurrence of the threat 701 to “http://xxx.xxx.co.jp/iot”, and inquires about the presence or absence of occurrence of “fire”. As required, the query unit 606 may transmit “SC”, “HD”, and “SS” as machine classification IDs 741.

Since the process at step S2001 is identical to that of Embodiment 1 illustrated in FIG. 17, description is omitted.

At step S3501, the query response unit 622 of the machine management device 105 receives, via the first communication module 505, the query about the presence or absence of occurrence of the threat 701 from the network device 131. The query about the presence or absence of occurrence of the threat 701 includes the threat ID 702, the location 721 of occurrence of the threat 701, and the time of occurrence of the threat 701. In the present example, as the query about the presence or absence of occurrence of the threat 701, the machine management device 105 at “XXX prefecture, XXX city, XXX town, X-X, X building” receives “T001” as the threat ID 702 and “XXX prefecture, XXX city, XXX town, X-X, X building” as the location 721 of occurrence of the threat 701 as well as the time of occurrence of the threat 701. Note that, as required, the machine management device 105 may receive “SC”, “HD”, and “SS” as the machine classification IDs 741.

At step S3502, the data acquisition unit 623 of the machine management device 105 extracts the threat ID 702, the location 721 of occurrence of the threat 701, and the time of occurrence of the threat 701 from the query about the presence or absence of occurrence of the threat 701 received by the query response unit 622. If the machine classification IDs 741 are also transmitted as parameters of the URL 731 or the like, the data acquisition unit 623 also extracts the machine classification IDs 741. Based on the threat ID 702 and the location 721 of occurrence extracted from the query about the presence or absence of occurrence of the threat 701, the data acquisition unit 623 acquires, from the correspondence table 682 of the installation location database 633, the machine IDs 771 of the machines to be checked and the state changes 751 of the machines at the time of occurrence of the threat 701. Note that the data acquisition unit 623 may also use the machine classification IDs 741 as required together with the threat ID 702 to acquire the machine IDs 771 of the machines to be checked and the state changes 751 of the machines at the time of occurrence of the threat 701. In the present example, for the threat ID 702 “T001” corresponding to “fire”, since the floor where the threat 701 is occurring is not indicated, the machine IDs 771 at “XXX prefecture, XXX city, XXX town, X-X, X building” are “SC0100”, “SC0110”, “SC0120”, . . . ; “HD0100”, “HD0110”, “HD0120”, . . . ; and “SS0100”, “SS0110”, “SS0120”, . . . . At each of “surveillance cameras” with “SC0100”, “SC0110”, “SC0120”, . . . , when “video of fire” shows up, this means that “fire” is occurring. At each of “heat detection sensors” with “HD0100”, “HD0110”, “HD0120”, . . . , when heat is “detected”, this means that “fire” is occurring. At each of “smoke detection sensors” with “SS0100”, “SS0110”, “SS0120”, . . . , when smoke is “detected”, this means that “fire” is occurring.

At step S3503, based on the acquired machine IDs 771 and the time of occurrence extracted from the query about the presence or absence of occurrence of the threat 701, the data acquisition unit 623 acquires, from the observation database 631, observation data around the time of occurrence of the threat 701. In the present example, the data acquisition unit 623 acquires, from the observation database 631, observation data of the surveillance camera 112 and the sensor 113 corresponding to “SC0100”, “SC0110”, “SC0120”, . . . ; “HD0100”, “HD0110”, “HD0120”, . . . ; and “SS0100”, “SS0110”, “SS0120”, . . . around the time of occurrence of the threat 701. “Around the time of occurrence” is, for example, from one hour before the time of occurrence to the time of occurrence.

At step S3504, the event determination unit 624 of the machine management device 105 analyzes the observation data acquired by the data acquisition unit 623 from the observation database 631 to determine whether the state change 751 of each machine at the time of occurrence of the threat 701 is occurring. In the observation data, when the state change 751 of the machine occurs, this means that the threat 701 is occurring. When the state change 751 is not occurring, this means that the threat is not occurring. When the observation data is image data acquired from the surveillance camera 112, the event determination unit 624 uses AI technology such as image recognition technology or machine learning, to determine whether the state change 751 is occurring. When the presence or absence of occurrence of the threat 701 is determined from the observation data of a plurality of machines corresponding to different machine classification IDs 741, which determination criterion is to be used may be freely set by the administrator of the machine management device 105. In the present example, if “video of fire” shows up in any of image data “SC0100”, “SC0110”, “SC0120”, . . . ; heat is “detected” in any of data “HD0100”, “HD0110”, “HD0120”, . . . ; and smoke is “detected” in any of data “SS0100”, “SS0110”, “SS0120”, . . . , it is determined that “fire” is occurring.

At step S1307 and step S3505, the query response unit 622 transmits, via the first communication module 505, the determination result as to the presence or absence of occurrence of the threat 701 by the event determination unit 624 to the network device 131 as a response to the query about the presence or absence of occurrence of the threat 701.

At step S3410, the query unit 606 of the network device 131 receives, via the communication module group 805 from all machine management devices 105 as query destinations, the determination result as to the presence or absence of occurrence of the threat 701.

At step S3411, based on the determination result as to the presence or absence of occurrence of the threat 701 received by the query unit 606, the result reflecting unit 607 of the network device 131 determines whether the submitted article is true or false. The criteria for true/false determination when a query is transmitted to a plurality of machine management devices 105 may be freely set by the administrator of the network device 131. At step S3412, a branch process in accordance with the determination result at step S3411 is performed. When it is determined at step S3411 that the submitted article is true, a process at step S3414 is performed. When it is determined at step S3411 that the submitted article is false, a process at step S3413 is performed.

At step S3413, the result reflecting unit 607 provides a mark indicating that it is false to the submitted article or deletes the submitted article, and transfers the submitted article with the true/false determination result reflected therein via the communication module group 805 to the terminal 102 connected via the LAN 132. The submission viewing unit 601 of the terminal 102 receives the article transferred from the network device 131 via the communication module 205 to allow the submitter 121 to view the article. Alternatively, at step S3413, via the communication module group 805, the result reflecting unit 607 provides a mark indicating that it is false to the submitted article or deletes the submitted article, and requests the SNS server 103 to reflect the true/false determination result in the submitted article. Upon request, the SNS providing unit 602 of the SNS server 103 distributes the submitted article with the true/false determination result reflected therein via the communication module group 805 to the network device 131. At step S3302 and step S3414, the transfer processing unit 609 of the network device 131 transfers the submitted article with the true/false determination result reflected therein via the communication module group 805 to the terminal 102 connected via the LAN 132. The submission viewing unit 601 of the terminal 102 receives the article transferred from the network device 131 via the communication module 205 to allow the submitter 121 to view the article. Note that the transfer processing unit 609 of the network device 131 can relay communication other than that described above between the terminal 102 and the SNS server 103.

### Description of Effects of Embodiment

In the present embodiment, as with Embodiment 1 and Embodiment 2, it is possible to perform both of quickly taking measures against false submission by determining whether the contents of the submission are true or false from the observation result of the machine and handling the observation result of the machine as secret information.

In the present embodiment, as with Embodiment 1 and Embodiment 2, the false submitted article can be automatically and instantaneously deleted, or it can be displayed that the submitted article is a false article. As a result, it is possible to automatically prevent the false submitted article from being spread by readers motivated by fears and a social panic from being caused. Furthermore, the observation data of the surveillance camera 112 and the sensor 113 is handled as secret information of the management subject, and is not leaked outside the management subject.

### Other Configurations

As a modification example of the present embodiment, the DS server 104 may be unified into the network device 131.

In the present embodiment, the functions of the transfer processing unit 609, the submission determination unit 603, the event specifying unit 604, the query destination specifying unit 605, the query unit 606, and the result reflecting unit 607 of the network device 131 are implemented by software. As a modification example, the functions of the transfer processing unit 609, the submission determination unit 603, the event specifying unit 604, the query destination specifying unit 605, the query unit 606, and the result reflecting unit 607 may be implemented by hardware. That is, the network device 131 may include dedicated hardware which implements the functions of the transfer processing unit 609, the submission determination unit 603, the event specifying unit 604, the query destination specifying unit 605, the query unit 606, and the result reflecting unit 607. This dedicated hardware is, for example, a single circuit, composite circuit, programmed processor, parallel-programmed processor, logic IC, GA, FPGA, or ASIC.

As another modification example, the functions of the transfer processing unit 609, the submission determination unit 603, the event specifying unit 604, the query destination specifying unit 605, the query unit 606, and the result reflecting unit 607 may be implemented by a combination of software and hardware. That is, the functions of the transfer processing unit 609, the submission determination unit 603, the event specifying unit 604, the query destination specifying unit 605, the query unit 606, and the result reflecting unit 607 may be partially implemented by dedicated hardware and the rest may be implemented by software.

The processor 201 and dedicated hardware are both processing circuits. That is, irrespective of being implemented by any of software, hardware, and a combination of software and hardware, the functions of the transfer processing unit 609, the submission determination unit 603, the event specifying unit 604, the query destination specifying unit 605, the query unit 606, and the result reflecting unit 607 are exerted by the processing circuits.

### REFERENCE SIGNS LIST

100: false submission filter system; 101: Internet; 102: terminal; 103: SNS server; 104: DS server; 105: machine management device; 111: network; 112: surveillance camera; 113: sensor; 121: submitter; 131: network device; 132: LAN; 201: processor; 202: memory; 203: auxiliary storage device; 204: input/output interface; 205: communication module; 206: bus; 301: processor; 302: memory; 303: auxiliary storage device; 304: input/output interface; 305: communication module; 306: bus; 401: processor; 402: memory; 403: auxiliary storage device; 404: input/output interface; 405: communication module; 406: bus; 501: processor; 502: memory; 503: auxiliary storage device; 504: input/output interface; 505: first communication module; 506: bus; 507: second communication module; 601: submission viewing unit; 602: SNS providing unit; 603: submission determination unit; 604: event specifying unit; 605: query destination specifying unit; 606: query unit; 607: result reflecting unit; 608: search processing unit; 609: transfer processing unit; 611: submission database; 612: machine database; 613: query destination database; 621: observation unit; 622: query response unit; 623: data acquisition unit; 624: event determination unit; 631: observation database; 632: state change database; 633: installation location database; 641: threat determination unit; 642: joke determination unit; 651: threat extraction unit; 652: location specifying unit; 661: first information extraction unit; 662: second information extraction unit; 663: third information extraction unit; 664: fourth information extraction unit; 665: location determination unit; 671: correspondence table; 672: correspondence table; 681: correspondence table; 682: correspondence table; 701: threat; 702: threat ID; 711: machine type; 712: machine type ID; 721: location; 722: address; 723: longitude and latitude; 731: URL; 741: machine classification ID; 742: machine classification; 751: state change; 761: installation location; 771: machine ID; 772: machine name; 801: processor; 802: memory; 803: auxiliary storage device; 804: input/output interface; 805: communication module group; 806: bus

1-11. (canceled)

12. A false submission filter device comprising:
an event specifying unit to analyze contents of a submission informing of an occurrence of an event and to specify a location of occurrence of the event;
a query destination specifying unit to search a query destination database which stores data associating locations observed by one or more machines and query destinations of a management subject which manages the one or more machines and to specify a query destination corresponding to the location specified by the event specifying unit;
a query unit to transmit a request for checking presence or absence of occurrence of the event from the observation result of the one or more machines to the query destination specified by the query destination specifying unit and to receive a response to the request; and
a result reflecting unit to determine whether the contents of the submission are true or false from a check result indicated by the response received by the query unit and to perform a process in accordance with a determination result on the submission,
wherein
the event specifying unit specifies the location of occurrence of the event from text or an image included in the submission, and
when different locations are specified by the event specifying unit from the text and the image, the result reflecting unit determines that the contents of the submission are false and omits transmission of the request by the query unit.

13. The false submission filter device according to claim 12, wherein
the event specifying unit specifies the location of occurrence of the event by referring to position information added to the text or the image.

14. The false submission filter device according to claim 12, wherein
the event specifying unit analyzes the contents of the submission and further specifies a time of occurrence of the event, and
the query unit causes information about the time specified by the event specifying unit to be included in the request, transmits the request for checking the presence or absence of occurrence of the event at the time specified by the event specifying unit from the observation result of the one or more machines.

15. The false submission filter device according to claim 12, wherein
the event specifying unit analyses the contents of the submission and further specifies a threat occurring as the event,
the query unit searches a machine database which stores data specifying machine types corresponding to threats, specifies a machine type corresponding to the threat specified by the event specifying unit, and causes information about the specified machine type to be included in the request, transmits the request for checking presence or absence of occurrence of the event from the observation result of a machine relevant to the specified machine type.

16. The false submission filter device according to claim 12, wherein
the false submission filter device is a server to accept the submission from a terminal of a user and to publish the submission on a network.

17. The false submission filter device according to claim 12, wherein
the false submission filter device is a terminal of a user who uses a service for publishing the submission on a network.

18. The false submission filter device according to claim 12, wherein
the false submission filter device is a network device installed between a terminal of a user and a server which accepts the submission from the terminal of the user and publishes the submission on a network.

19. A false submission filter system comprising:
the false submission filter device according to claim 12; and
a machine management device to receive the request transmitted from the query unit, to acquire the observation result of the one or more machines in response to the received request, to check the presence or absence of occurrence of the event from the acquired observation result, and to transmit a response indicating the check result.

20. A false submission filter method comprising:
by a false submission filter device, analyzing contents of a submission informing of an occurrence of an event, specifying a location of occurrence of the event, searching a query destination database which stores data associating locations observed by one or more machines and query destinations of a management subject which manages the one or more machines, specifying a query destination corresponding to the specified location, and transmitting a request for checking presence or absence of occurrence of the event from the observation result of the one or more machines to the specified query destination;
by a machine management device, receiving the request transmitted from the false submission filter device, acquiring the observation result of the one or more machines in response to the received request, checking the presence or absence of occurrence of the event from the acquired observation result, and transmitting a response indicating a check result;
by the false submission filter device, receiving the response transmitted from the machine management device, determining whether the contents of the submission are true or false from the check result indicated by the received response, and performing a process corresponding to a determination result on the submission; and
by the false submission filter device, specifying the location of occurrence of the event from text or an image included in the submission, and when different locations are specified from the text and the image, determining that the contents of the submission are false and omitting transmission of the request.

21. A non-transitory computer readable medium storing a false submission filter program that causes a computer
to execute:
an event specifying procedure of analyzing contents of a submission informing of an occurrence of an event and specifying a location of occurrence of the event;
a query destination specifying procedure of searching a query destination database which stores data associating locations observed by one or more machines and query destinations of a management subject which manages the one or more machines and specifying a query destination corresponding to the location specified by the event specifying procedure;
a query procedure of transmitting a request for checking presence or absence of occurrence of the event from the observation result of the one or more machines to the query destination specified by the query destination specifying procedure and receiving a response to the request; and
a result reflection procedure of determining whether the contents of the submission are true or false from a check result indicated by the response received by the query procedure and performing a process in accordance with a determination result on the submission;
to specify the location of occurrence of the event from text or an image included in the submission by the event specifying procedure, and
when different locations are specified by the event specifying procedure from the text and the image, to determine the contents of the submission are false by the result reflection procedure, and omit transmission of the request by the query procedure.
